(19) United States
(12) Patent Application Publication
(10) Pub. No.: US 2025/0168657 A1
(43) Pub. Date: May 22, 2025

(54) STORING DOWNLINK CHANNEL MEASUREMENTS ASSOCIATED WITH ONE OR MORE TIME INSTANCES AT A USER EQUIPMENT

(71) Applicant: QUALCOMM Incorporated, San Diego, CA (US)

(72) Inventors: Qiaoyu LI, Beijing (CN); Taesang YOO, San Diego, CA (US); Mahmoud TAHERZADEH BOROUJENI, San Diego, CA (US); Hamed PEZESHKI, San Diego, CA (US); Tianyang BAI, Mountain View, CA (US); Tao LUO, San Diego, CA (US)

(21) Appl. No.: 18/838,362

(22) PCT Filed: Mar. 29, 2023
(86) PCT No.: PCT/CN2023/084718

§ 371 Date: Aug. 14, 2024

(30) Foreign Application Priority Data
Apr. 29, 2022 (WO) PCT/CN2022/090376
Apr. 29, 2022 (WO) PCT/CN2022/090414

(51) Int. Cl. H04W 24/02; H04W 8/22; H04W 24/10

(52) U.S. Cl. CPC H04W 24/02; H04W 8/22; H04W 24/10

(57) ABSTRACT

Various aspects of the present disclosure generally relate to wireless communication. In some aspects, a user equipment (UE) may receive, from a network entity, a configuration associated with channel measurement resources (CMRs). The UE may perform downlink channel measurements associated with the CMRs, wherein the downlink channel measurements are associated with one or more time instances. The UE may store the downlink channel measurements associated with the one or more time instances for a period of time at the UE. The UE may transmit, to the network entity and based at least in part on a request, at least a portion of the downlink channel measurements associated with the one or more time instances. Numerous other aspects are described.

### CROSS-REFERENCE TO RELATED APPLICATION

This Patent application claims priority to International Patent Application No. PCT/CN2022/090376, filed on Apr. 29, 2022, entitled “STORING DOWNLINK CHANNEL MEASUREMENTS ASSOCIATED WITH ONE OR MORE TIME INSTANCES AT A USER EQUIPMENT,” and International Patent Application No. PCT/CN2022/090414, filed on Apr. 29, 2022, entitled “RETRANSMISSION OF CHANNEL STATE INFORMATION REPORT FOR MACHINE LEARNING BASED PREDICTION,” and assigned to the assignee hereof. The disclosures of the prior Applications are considered part of and are incorporated by reference into this Patent Application.

### FIELD OF THE DISCLOSURE

Aspects of the present disclosure generally relate to wireless communication and to techniques and apparatuses for storing downlink channel measurements associated with one or more time instances at a user equipment (UE).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: receive, from a network entity, a configuration associated with channel measurement resources (CMRs); perform downlink channel measurements associated with the CMRs, wherein the downlink channel measurements are associated with one or more time instances; store the downlink channel measurements associated with the one or more time instances for a period of time at the UE; and transmit, to the network entity and based at least in part on a request, at least a portion of the downlink channel measurements associated with the one or more time instances.

In some implementations, an apparatus for wireless communication at a network entity includes a memory and one or more processors, coupled to the memory, configured to: transmit, to a UE, a configuration associated with CMRs; and receive, from the UE and based at least in part on a request, at least a portion of downlink channel measurements stored for a period of time at the UE, wherein the downlink channel measurements are associated with the CMRs and with one or more time instances.

In some implementations, a method of wireless communication performed by a UE includes receiving, from a network entity, a configuration associated with CMRs; performing downlink channel measurements associated with the CMRs, wherein the downlink channel measurements are associated with one or more time instances; storing the downlink channel measurements associated with the one or more time instances for a period of time at the UE; and transmitting, to the network entity and based at least in part on a request, at least a portion of the downlink channel measurements associated with the one or more time instances.

In some implementations, a method of wireless communication performed by a network entity includes transmitting, to a UE, a configuration associated with CMRs; and receiving, from the UE and based at least in part on a request, at least a portion of downlink channel measurements stored for a period of time at the UE, wherein the downlink channel measurements are associated with the CMRs and with one or more time instances.

In some implementations, a non-transitory computer-readable medium storing a set of instructions for wireless communication includes one or more instructions that, when executed by one or more processors of a UE, cause the UE to: receive, from a network entity, a configuration associated with CMRs; perform downlink channel measurements associated with the CMRs, wherein the downlink channel measurements are associated with one or more time instances; store the downlink channel measurements associated with the one or more time instances for a period of time at the UE; and transmit, to the network entity and based at least in part on a request, at least a portion of the downlink channel measurements associated with the one or more time instances.

In some implementations, a non-transitory computer-readable medium storing a set of instructions for wireless communication includes one or more instructions that, when executed by one or more processors of a network entity, cause the network entity to: transmit, to a UE, a configuration associated with CMRs; and receive, from the UE and based at least in part on a request, at least a portion of downlink channel measurements stored for a period of time at the UE, wherein the downlink channel measurements are associated with the CMRs and with one or more time instances.

In some implementations, an apparatus for wireless communication includes means for receiving, from a network entity, a configuration associated with CMRs; means for performing downlink channel measurements associated with the CMRs, wherein the downlink channel measurements are associated with one or more time instances; means for storing the downlink channel measurements associated with the one or more time instances for a period of time at the apparatus; and means for transmitting, to the network entity and based at least in part on a request, at least a portion of the downlink channel measurements associated with the one or more time instances.

In some implementations, an apparatus for wireless communication includes means for transmitting, to a UE, a configuration associated with CMRs; and means for receiving, from the UE and based at least in part on a request, at least a portion of downlink channel measurements stored for a period of time at the UE, wherein the downlink channel measurements are associated with the CMRs and with one or more time instances.

In some implementations, an apparatus for wireless communication at a UE includes a memory and one or more processors, coupled to the memory, configured to: receive a configuration for periodic or aperiodic channel state information (CSI) reporting; transmit a first CSI report, in accordance with the configuration for periodic or aperiodic CSI reporting; and transmit an aperiodic second CSI report containing one or more channel characteristic measurements associated with the first CSI report, if one or more conditions are met.

In some implementations, an apparatus for wireless communication at a network entity includes a memory and one or more processors, coupled to the memory, configured to: transmit a configuration to configure a UE for periodic or aperiodic CSI reporting; receive a first CSI report, generated by the UE in accordance with the configuration for periodic or aperiodic CSI reporting; and receive an aperiodic second CSI report generated by the UE if one or more conditions are met, the second CSI report containing one or more channel characteristic measurements associated with the first CSI report.

In some implementations, a method of wireless communication by a UE includes receiving a configuration for periodic or aperiodic CSI reporting; transmitting a first CSI report, in accordance with the configuration for periodic or aperiodic CSI reporting; and transmitting an aperiodic second CSI report containing one or more channel characteristic measurements associated with the first CSI report, if one or more conditions are met.

In some implementations, a method of wireless communication by a network entity includes transmitting a configuration to configure a UE for periodic or aperiodic CSI reporting; receiving a first CSI report, generated by the UE in accordance with the configuration for periodic or aperiodic CSI reporting; and receiving an aperiodic second CSI report generated by the UE if one or more conditions are met, the second CSI report containing one or more channel characteristic measurements associated with the first CSI report.

In some implementations, a non-transitory computer-readable medium storing a set of instructions for wireless communication includes one or more instructions that, when executed by one or more processors of a UE, cause the UE to: receive a configuration for periodic or aperiodic CSI reporting; transmit a first CSI report, in accordance with the configuration for periodic or aperiodic CSI reporting; and transmit an aperiodic second CSI report containing one or more channel characteristic measurements associated with the first CSI report, if one or more conditions are met.

In some implementations, a non-transitory computer-readable medium storing a set of instructions for wireless communication includes one or more instructions that, when executed by one or more processors of a network entity, cause the network entity to: transmit a configuration to configure a UE for periodic or aperiodic CSI reporting; receive a first CSI report, generated by the UE in accordance with the configuration for periodic or aperiodic CSI reporting; and receive an aperiodic second CSI report generated by the UE if one or more conditions are met, the second CSI report containing one or more channel characteristic measurements associated with the first CSI report.

In some implementations, an apparatus for wireless communication includes means for receiving a configuration for periodic or aperiodic CSI reporting; means for transmitting a first CSI report, in accordance with the configuration for periodic or aperiodic CSI reporting; and means for transmitting an aperiodic second CSI report containing one or more channel characteristic measurements associated with the first CSI report, if one or more conditions are met.

In some implementations, an apparatus for wireless communication includes means for transmitting a configuration to configure a UE for periodic or aperiodic CSI reporting; means for receiving a first CSI report, generated by the UE in accordance with the configuration for periodic or aperiodic CSI reporting; and means for receiving an aperiodic second CSI report generated by the UE if one or more conditions are met, the second CSI report containing one or more channel characteristic measurements associated with the first CSI report.

Aspects generally include a method, apparatus, system, computer program product, non-transitory computer-readable medium, user equipment, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a disaggregated base station architecture, in accordance with the present disclosure.

FIG. 4 is a diagram illustrating examples of beam management procedures, in accordance with the present disclosure.

FIG. 5 is a diagram illustrating an example of beam management, in accordance with the present disclosure.

FIG. 6 is a diagram illustrating an example of an artificial intelligence (AI)/machine learning (ML) based time domain beam prediction, in accordance with the present disclosure.

FIG. 7 is a diagram illustrating an example associated with storing downlink channel measurements associated with one or more time instances at a UE, in accordance with the present disclosure.

FIGS. 8-9 are diagrams illustrating example processes associated with storing downlink channel measurements associated with one or more time instances at a UE, in accordance with the present disclosure.

FIGS. 10-11 are diagrams of example apparatuses for wireless communication, in accordance with the present disclosure.

FIG. 12 depicts a diagram illustrating missing channel state information (CSI) reports, in accordance with the present disclosure.

FIG. 13 depicts a call flow diagram for retransmitting CSI information, in accordance with the present disclosure.

FIG. 14 depicts a diagram illustrating buffering and retransmission layer 1 (L1) reports for ML based time domain (TD) beam prediction, in accordance with the present disclosure.

FIG. 15 depict tables describing explicitly reported UE capabilities, in accordance with the present disclosure.

FIG. 16 depicts a timeline associated with implicit UE capability reporting via CSI processing units (CPUs), in accordance with the present disclosure.

FIG. 17 depict diagrams illustrating options for buffer release and replacement, in accordance with the present disclosure.

FIG. 18 depicts a diagram illustrating triggering of a second aperiodic (AP) CSI report, in accordance with the present disclosure.

FIG. 19 depicts a diagram illustrating medium access control control element (MAC-CE) based uplink control information (UCI) retransmission, in accordance with the present disclosure.

FIG. 20 depicts a diagram illustrating extensions to reporting additional CSI information, in accordance with the present disclosure.

FIGS. 21-22 are diagrams illustrating example processes associated with a retransmission of a CSI report for an ML based prediction, in accordance with the present disclosure.

FIGS. 23-24 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

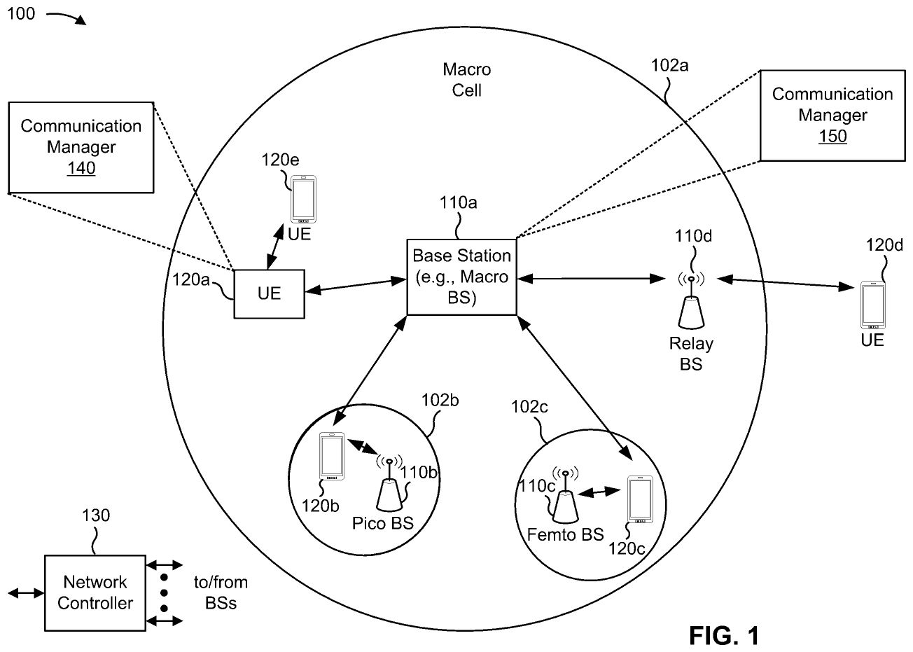

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive, from a network entity, a configuration associated with channel measurement resources (CMRs); perform downlink channel measurements associated with the CMRs, wherein the downlink channel measurements are associated with one or more time instances; store the downlink channel measurements associated with the one or more time instances for a period of time at the UE; and transmit, to the network entity and based at least in part on a request, at least a portion of the downlink channel measurements associated with the one or more time instances. As described in more detail elsewhere herein, the communication manager 140 may receive a configuration for periodic or aperiodic channel state information (CSI) reporting; transmit a first CSI report, in accordance with the configuration for periodic or aperiodic CSI reporting; and transmit an aperiodic second CSI report containing one or more channel characteristic measurements associated with the first CSI report, if one or more conditions are met. Additionally, or alternatively, the communication manager 140 may perform one or more other operations described herein.

In some aspects, a network entity (e.g., base station 110) may include a communication manager 150. As described in more detail elsewhere herein, the communication manager 150 may transmit, to a UE, a configuration associated with CMRs; and receive, from the UE and based at least in part on a request, at least a portion of downlink channel measurements stored for a period of time at the UE, wherein the downlink channel measurements are associated with the CMRs and with one or more time instances. As described in more detail elsewhere herein, the communication manager 150 may transmit a configuration to configure a UE for periodic or aperiodic CSI reporting; receive a first CSI report, generated by the UE in accordance with the configuration for periodic or aperiodic CSI reporting; and receive an aperiodic second CSI report generated by the UE if one or more conditions are met, the second CSI report containing one or more channel characteristic measurements associated with the first CSI report. Additionally, or alternatively, the communication manager 150 may perform one or more other operations described herein.

As indicated above, FIG. 1 is provided as an example. Other examples may differ from what is described with regard to FIG. 1.

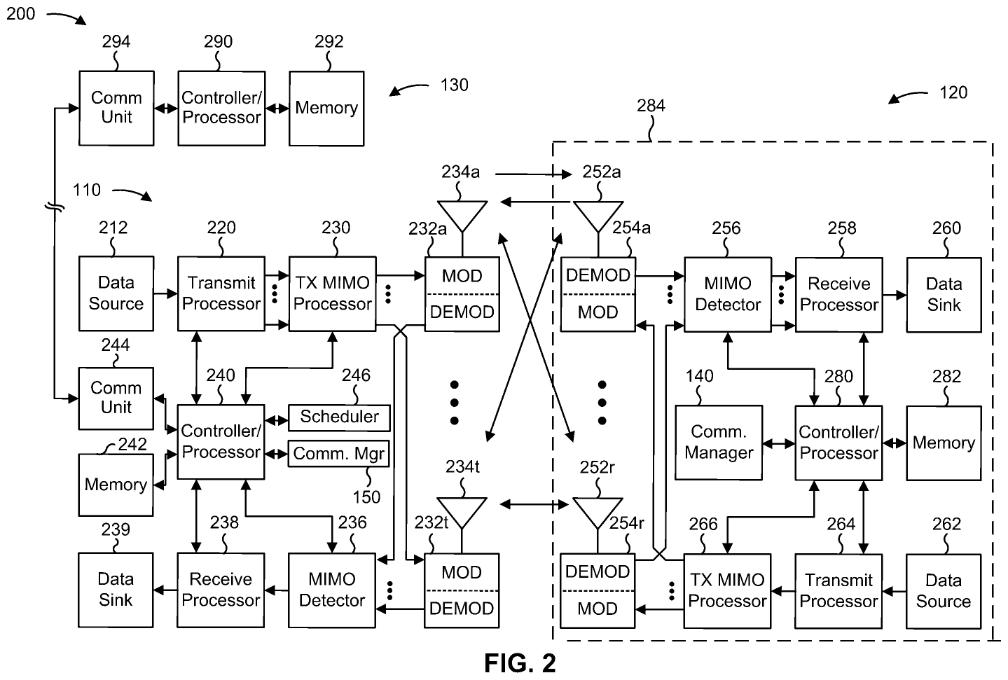

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

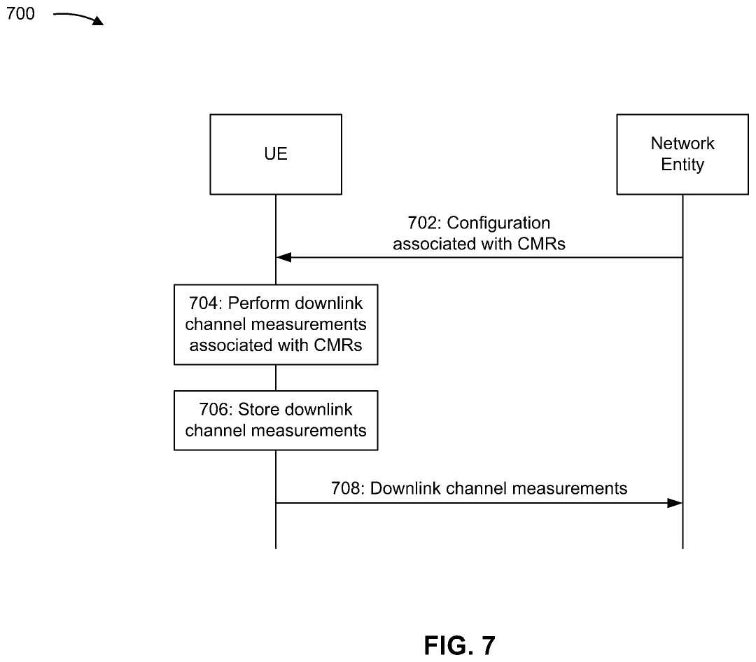

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-11).

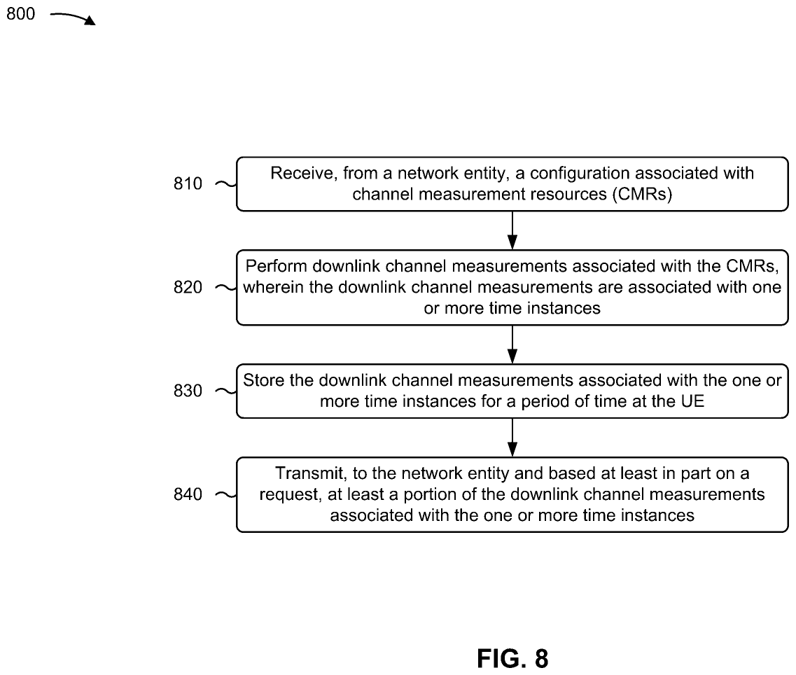

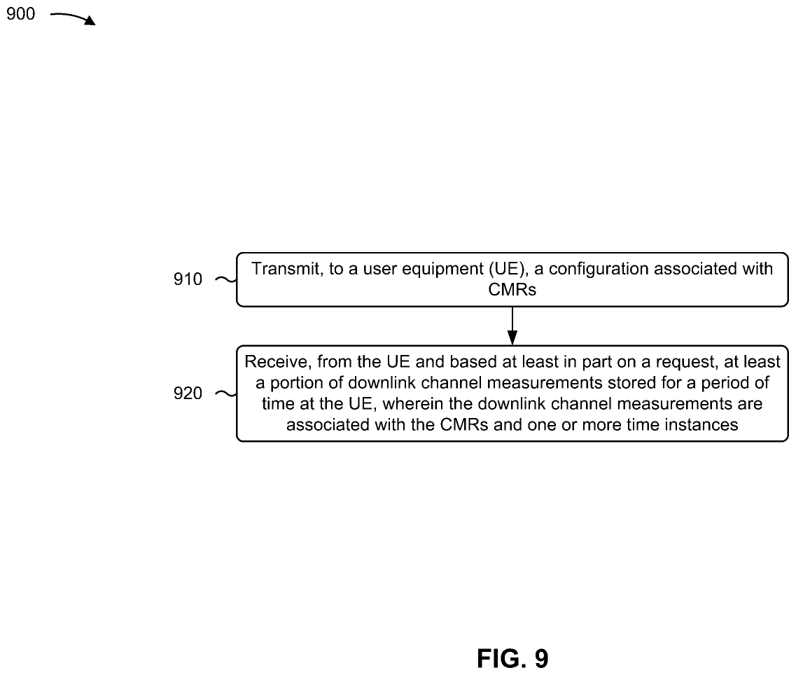

The controller/processor 240 of the base station 110, the controller/processor 280 of the UE 120, and/or any other component(s) of FIG. 2 may perform one or more techniques associated with storing downlink channel measurements associated with one or more time instances at a UE, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a UE (e.g., UE 120) includes means for receiving, from a network entity, a configuration associated with CMRs; means for performing downlink channel measurements associated with the CMRs, wherein the downlink channel measurements are associated with one or more time instances; means for storing the downlink channel measurements associated with the one or more time instances for a period of time at the UE; and/or means for transmitting, to the network entity and based at least in part on a request, at least a portion of the downlink channel measurements associated with the one or more time instances. In some aspects, the UE (e.g., UE 120) includes means for receiving a configuration for periodic or aperiodic CSI reporting; means for transmitting a first CSI report, in accordance with the configuration for periodic or aperiodic CSI reporting; and means for transmitting an aperiodic second CSI report containing one or more channel characteristic measurements associated with the first CSI report, if one or more conditions are met. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., base station 110) includes means for transmitting, to a UE, a configuration associated with CMRs; and/or means for receiving, from the UE and based at least in part on a request, at least a portion of downlink channel measurements stored for a period of time at the UE, wherein the downlink channel measurements are associated with the CMRs and with one or more time instances. In some aspects, a network entity (e.g., base station 110) includes means for transmitting a configuration to configure a UE for periodic or aperiodic CSI reporting; means for receiving a first CSI report, generated by the UE in accordance with the configuration for periodic or aperiodic CSI reporting; and means for receiving an aperiodic second CSI report generated by the UE if one or more conditions are met, the second CSI report containing one or more channel characteristic measurements associated with the first CSI report. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

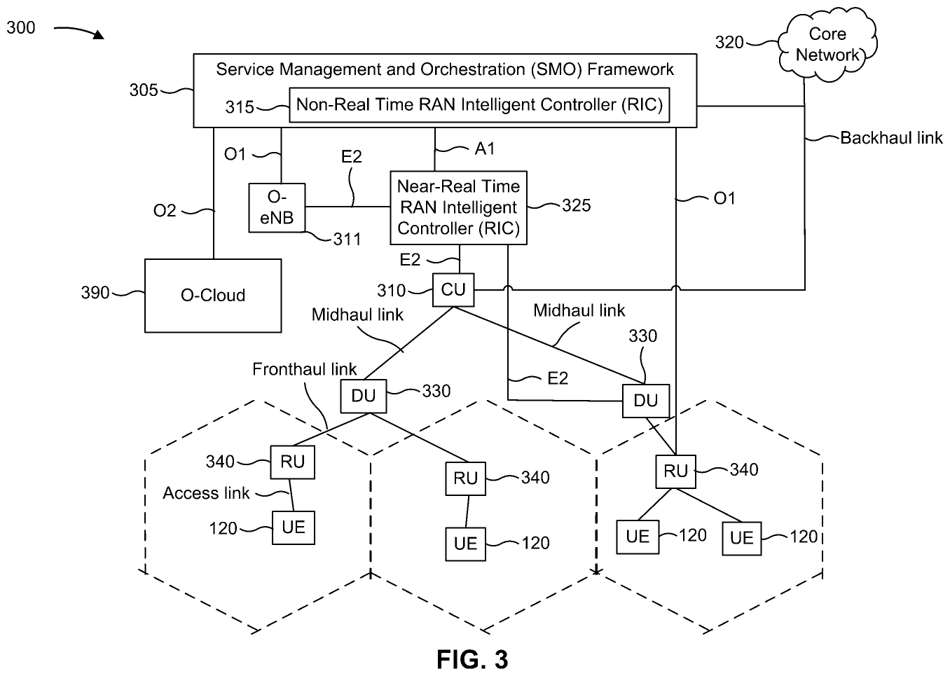

FIG. 3 is a diagram illustrating an example 300 of a disaggregated base station architecture, in accordance with the present disclosure.

Deployment of communication systems, such as 5G NR systems, may be arranged in multiple manners with various components or constituent parts. In a 5G NR system, or network, a network entity, a network entity, a mobility element of a network, a RAN node, a core network entity, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, AP, a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual centralized unit (VCU), a virtual distributed unit (VDU), or a virtual radio unit (VRU)).

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

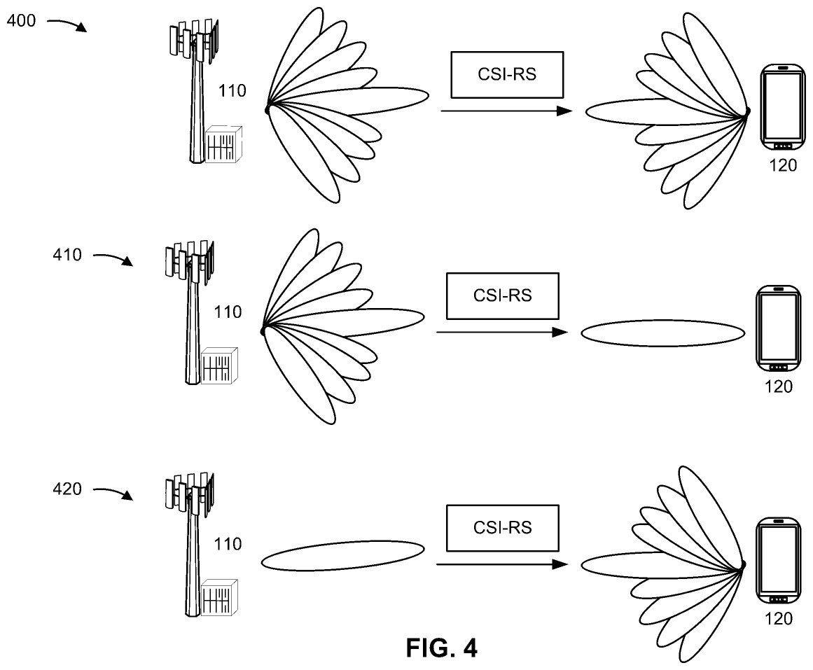

FIG. 4 is a diagram illustrating examples 400, 410, and 420 of beam management procedures, in accordance with the present disclosure. As shown in FIG. 4, examples 400, 410, and 420 include a UE 120 in communication with a base station 110 in a wireless network (e.g., wireless network 100). However, the devices shown in FIG. 4 are provided as examples, and the wireless network may support communication and beam management between other devices (e.g., between a UE 120 and a base station 110 or TRP, between a mobile termination node and a control node, between an IAB child node and an IAB parent node, and/or between a scheduled node and a scheduling node). In some aspects, the UE 120 and the base station 110 may be in a connected state (e.g., an RRC connected state).

As shown in FIG. 4, example 400 may include a base station 110 and a UE 120 communicating to perform beam management using channel state information reference signals (CSI-RSs). Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the base station 110 to the UE 120. The CSI-RSs may be configured to be periodic (e.g., using RRC signaling), semi-persistent (e.g., using MAC control element (MAC-CE) signaling), and/or aperiodic (e.g., using downlink control information (DCI)).

The first beam management procedure may include the base station 110 performing beam sweeping over multiple transmit (Tx) beams. The base station 110 may transmit a CSI-RS using each transmit beam for beam management. To enable the UE 120 to perform receive (Rx) beam sweeping, the base station may use a transmit beam to transmit (e.g., with repetitions) each CSI-RS at multiple times within the same RS resource set so that the UE 120 may sweep through receive beams in multiple transmission instances. For example, if the base station 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the base station 110, the UE 120 may perform beam sweeping through the receive beams of the UE 120. As a result, the first beam management procedure may enable the UE 120 to measure a CSI-RS on different transmit beams using different receive beams to support selection of base station 110 transmit beams/UE 120 receive beam(s) beam pair(s). The UE 120 may report the measurements to the base station 110 to enable the base station 110 to select one or more beam pair(s) for communication between the base station 110 and the UE 120. While example 400 has been described in connection with CSI-RSs, the first beam management process may also use synchronization signal blocks (SSBs) for beam management in a similar manner as described above.

As shown in FIG. 4, example 410 may include a base station 110 and a UE 120 communicating to perform beam management using CSI-RSs. Example 410 depicts a second beam management procedure (e.g., P2 CSI-RS beam management). The second beam management procedure may be referred to as a beam refinement procedure, a base station beam refinement procedure, a TRP beam refinement procedure, and/or a transmit beam refinement procedure. As shown in FIG. 4 and example 410, CSI-RSs may be configured to be transmitted from the base station 110 to the UE 120. The CSI-RSs may be configured to be aperiodic (e.g., using DCI). The second beam management procedure may include the base station 110 performing beam sweeping over one or more transmit beams. The one or more transmit beams may be a subset of all transmit beams associated with the base station 110 (e.g., determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the base station 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the base station 110 to the UE 120. The CSI-RSs may be configured to be aperiodic (e.g., using DCI). The third beam management process may include the base station 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same RS resource set so that UE 120 may sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the base station 110 and/or the UE 120 to select a best receive beam based at least in part on reported measurements received from the UE 120 (e.g., of the CSI-RS of the transmit beam using the one or more receive beams).

As indicated above, FIG. 4 is provided as an example of beam management procedures. Other examples of beam management procedures may differ from what is described with respect to FIG. 4. For example, the UE 120 and the base station 110 may perform the third beam management procedure before performing the second beam management procedure, and/or the UE 120 and the base station 110 may perform a similar beam management procedure to select a UE transmit beam.

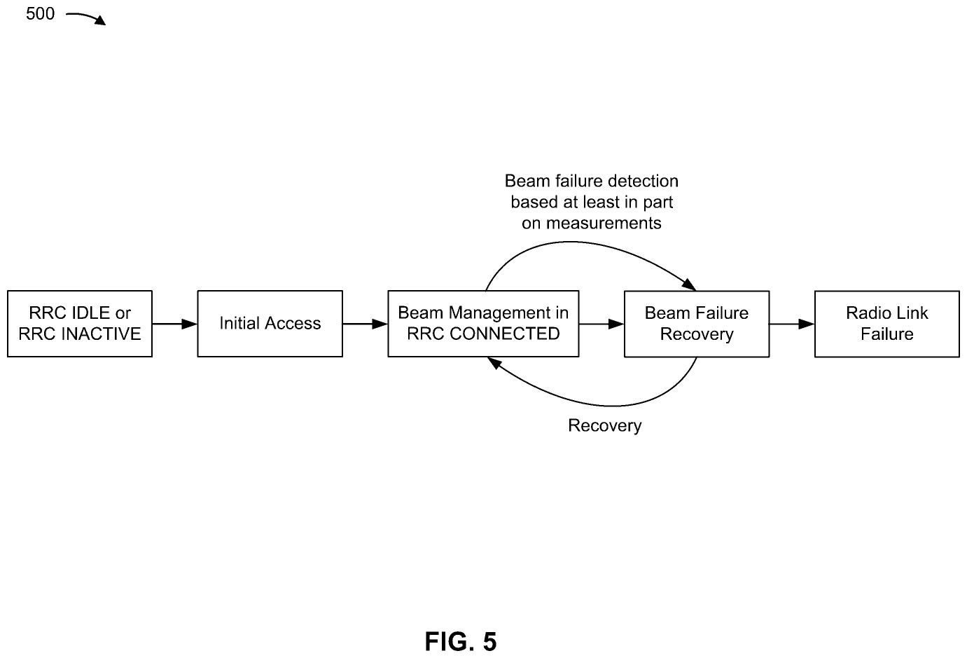

FIG. 5 is a diagram illustrating an example 500 of beam management, in accordance with the present disclosure.

As shown in FIG. 5, a UE may initially be in an RRC idle state or an RRC inactivate state. The UE may perform an initial access and beam management after entering an RRC connected state. The beam management may include P1, P2, and P3 beam management procedures, as described herein. The UE may also perform beam management using an AI/ML-based approach. The UE may perform a beam failure detection (BFD), and the UE may perform a beam failure recovery (BFR) based at least in part on the BFD. When the BFR is not successful, the UE may declare a radio link failure (RLF).

As indicated above, FIG. 5 is provided as an example. Other examples may differ from what is described with regard to FIG. 5.

AI/ML-based predictive beam management may involve beam management using AI/ML. One problem with traditional beam management procedures is that beam qualities/failures are always identified via measurements, which may involve more power/overhead needed to achieve good performance. Further, beam accuracy may be limited due to restrictions on power/overhead, and latency/throughput may be impacted by beam resuming efforts. AI/ML-based predictive beam management may provide predictive beam management in a spatial domain, time domain, and/or frequency domain, which may result in power/overhead reduction and/or accuracy/latency/throughput improvement. AI/ML-based predictive beam management may predict non-measured beam qualities, which may result in lower power/overhead or better accuracy. AI/ML-based predictive beam management may predict future beam blockage/failure, which may result in better latency/throughput. AI/ML-based predictive beam management may be useful because beam prediction is a highly non-linear problem. Predicting future Tx beam qualities may depend on a UE's moving speed/trajectory, Rx beams used or to be used, and/or interference, which may be difficult to model via conventional statistical signaling processing techniques.

AI/ML-based predictive beam management may involve the prediction of beams via AI/ML at the UE or at a network entity, which may involve a tradeoff between performance and UE power. In order to predict future DL-Tx beam qualities, the UE may have more observations (via measurements) than the network entity (via UE feedbacks). Thus, beam prediction at the UE may outperform beam prediction at the network entity, but may involve more UE power consumption. Model training may occur at the network entity or at the UE. For model training at the network entity, data may be collected via an enhanced air interface or via application-layer approaches. For model training at the UE, additional UE computation/buffering efforts may be needed by model training and data storage.

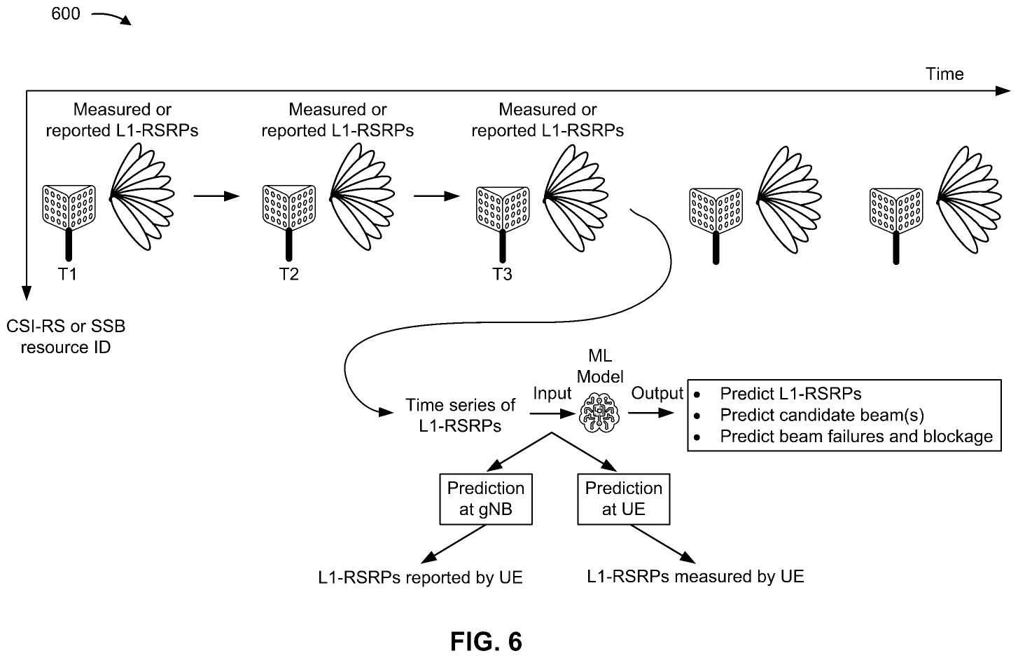

FIG. 6 is a diagram illustrating an example 600 of an AI/ML-based time domain beam prediction, in accordance with the present disclosure.

As shown in FIG. 6, in an AI/ML-based time domain beam prediction, the network entity may, at a first time, transmit a plurality of first CSI-RSs/SSBs. The first CSI-RSs/SSBs may be associated with first CMRs. The UE may perform layer 1 (L1)-RSRP measurements based at least in part on the plurality of first CSI-RSs/SSBs. The UE may report the first L1-RSRP measurements to the network entity. The network entity may, at a second time, transmit a plurality of second CSI-RSs/SSBs. The second CSI-RSs/SSBs may be associated with second CMRs. The UE may perform second L1-RSRP measurements based at least in part on the plurality of second CSI-RSs/SSBs. The UE may report the second L1-RSRP measurements to the network entity. The network entity may, at a third time, transmit a plurality of third CSI-RSs/SSBs. The third CSI-RSs/SSBs may be associated with third CMRs. The UE may perform third L1-RSRP measurements based at least in part on the plurality of third CSI-RSs/SSBs. The UE may report the third L1-RSRP measurements to the network entity. A time series of L1-RSRP measurements (e.g., the first, second, and third L1-RSRP measurements) may be provided as an input to an ML model. When beam prediction is performed at the network entity, the input may be L1-RSRP measurements reported by the UE. When the beam prediction is performed at the UE, the input may be L1-RSRP measurements measured by the UE. The ML model may produce an output based at least in part on the input, where the output may indicate a prediction of L1-RSRP measurements, a prediction of candidate beam(s), and/or a prediction of beam failure/blockage. The AI/ML-based time domain beam prediction may provide reduced UE power or UE-specific reference signal overhead, as well as better latency and throughput.

As indicated above, FIG. 6 is provided as an example. Other examples may differ from what is described with regard to FIG. 6.

Storing Downlink Channel Measurements Associated with Time Instance(s) at a UE

An AI/ML model residing at a UE may determine predicted downlink channel measurements (e.g., predicted future L1-RSRP measurements) based at least in part on a beam prediction carried out via the AI/ML model. The predicted downlink channel measurements may be based at least in part on an input, which may include past downlink channel measurements (e.g., past L1-RSRP measurements, which may correspond to UE reported channel characteristics). In some cases, the predicted downlink channel measurements may be associated with inference errors, which may occur at the UE due to environmental changes. A network entity may predict such inference errors by using uplink channel measurements together with the past downlink channel measurements. Network entity side inference error prediction may be based at least in part on conventional techniques and/or AI/ML-based techniques. When such inference errors are predicted, the network entity may request the UE to perform additional downlink channel measurements. The network entity may request the UE to report the additional downlink channel measurements (e.g., measured beam characteristics) together with the input associated with the predicted downlink channel measurements (e.g., input determining predicted beam characteristics), where the input may include the past downlink channel measurements. The additional downlink channel measurements may or may not be different than the predicted downlink channel measurements. Such inference error information may be used by the network entity to monitor the performance of the AI/ML model residing at the UE, as well as to gather additional data useable for refining the performance of the AI/ML model.

As an example, the UE may report predicted future L1-RSRP measurements to the network entity. Based at least in part on the request from the network entity (e.g., due to an inference error prediction at the network entity), the UE may measure and report actual L1-RSRP measurements (which may or may not be different than the predicted future L1-RSRP measurements). The UE may also report past L1-RSRP measurements that were used as input for determining the predicted future L1-RSRP measurements. The network entity may use the predicted future L1-RSRP measurements, the actual L1-RSRP measurements, and/or the past L1-RSRP measurements used as input for determining the predicted future L1-RSRP measurements to determine whether the predicted future L1-RSRP measurements are associated with inference errors.

However, the UE may not be configured to store the input for determining the predicted downlink channel measurements, where the input may be the downlink channel measurements. Rather, the UE may typically transmit some of the downlink channel measurements (e.g., measured beam characteristics of a strongest beam) to the network entity, and discard the remaining downlink channel measurements. The UE may not transmit all of the downlink channel measurements to the network entity, in order to reduce signaling, and the remaining downlink channel measurements are typically not useful for the network entity, and so may be discarded by the UE.

In various aspects of techniques and apparatuses described herein, a UE may receive, from a network entity, a configuration associated with CMRs. The UE may perform downlink channel measurements associated with the CMRs. The downlink channel measurements may be associated with one or more time instances. In some cases, the downlink channel measurements may be associated with a plurality of time instances (or a plurality of occasions). The UE may store the downlink channel measurements associated with the one or more time instances for a period of time at the UE. The UE may store the downlink channel measurements in a buffer of the UE. The UE may transmit, to the network entity and based at least in part on a request, at least a portion of the downlink channel measurements associated with the one or more time instances. The UE may transmit, based at least in part on the request, downlink channel measurements that were not previously transmitted to the network entity. The network entity may use the downlink channel measurements stored in the buffer of the UE for evaluating an AI/ML model for beam prediction that runs on the UE, where the AI/ML model may be used for determining predicted future downlink channel measurements based at least in part on the downlink channel measurements.

In some aspects, the UE may buffer the downlink channel measurements, and the UE may later transmit the downlink channel measurements to the network entity. The downlink channel measurements may be channel characteristic measurements, and may include L1-RSRP measurements. The UE may buffer the downlink channel measurements and wait to feed back buffered downlink channel measurements to the network entity. The UE may transmit the downlink channel measurements based at least in part on the request received from the network entity, or alternatively, based at least in part on the request transmitted by the UE to the network entity. In other words, the network entity may request the UE to transmit the downlink channel measurements, or alternatively, the UE may request to transmit the downlink channel measurements to the network entity without any request from the network entity. Further, the UE may indicate, to the network entity, capability information indicating whether the UE is capable of buffering the downlink channel measurements. The network entity may transmit the request for the downlink channel measurements to the UE based at least in part on the capability information indicating whether the UE is capable of buffering the downlink channel measurements.

FIG. 7 is a diagram illustrating an example 700 associated with storing downlink channel measurements associated with one or more time instances at a UE, in accordance with the present disclosure. As shown in FIG. 7, example 700 includes communication between a UE (e.g., UE 120) and a network entity (e.g., base station 110). In some aspects, the UE and the network entity may be included in a wireless network, such as wireless network 100.

As shown by reference number 702, the UE may receive, from the network entity, a configuration that indicates CMRs. The CMRs may be a set of CMRs. The configuration may indicate the CMRs for which the UE is to perform downlink channel measurements. The UE may be configured with the CMRs for performing the downlink channel measurements. Each CMR may be associated with a CSI-RS resource or an SSB resource, for which the UE may perform a downlink channel measurement. The UE may receive, from the network entity, CSI-RSs and/or SSBs based at least in part on CSI-RS resources and/or SSB resources, respectively, indicated by the configuration.

As shown by reference number 704, the UE may perform the downlink channel measurements (e.g., downlink channel characteristic measurements) of the CMRs indicated by the configuration. The downlink channel measurements may be associated with one or more time instances (e.g., a plurality of time instances), where the downlink channel measurements may be associated with the CMRs indicated by the configuration. The UE may perform the downlink channel measurements for the CSI-RS resources and/or the SSB resources associated with the CMRs. The downlink channel measurements may include L1-RSRP measurements, L1 signal-to-interference-plus-noise ratio (SINR) measurements, a rank indicator (RI), a precoding matrix indicator (PMI), and/or a CQI.

In some aspects, the UE may report some of the downlink channel measurements to the network entity. For example, the UE may report certain downlink channel measurements associated with a certain time instance (e.g., downlink channel measurements associated with strongest beams) to the network entity, which may enable the network entity to determine which beams are suitable for communicating with the UE. The UE may determine predicted future downlink channel measurements and/or the predicted candidate beams based at least in part on the downlink channel measurements. The UE may transmit, to the network entity, an indication of the predicted future downlink channel measurements and/or the predicted candidate beams. The UE may continue to store the downlink channel measurements, including downlink channel measurements associated with different time instances that are not transmitted to the network entity and/or downlink channel measurements associated with different time instances that are transmitted to the network entity.

As shown by reference number 706, the UE may store, at the UE and for a period of time, the downlink channel measurements of the CMRs indicated by the configuration. The UE may store the downlink channel measurements associated with the one or more time instances for the period of time at the UE. The UE may buffer (e.g., store in memory of the UE) the downlink channel measurements. For example, the UE may buffer all of the downlink channel measurements associated with the CMRs indicated by the configuration, which may include downlink channel measurements that were previously reported to the network entity and downlink channel measurements that were previously not reported to the network entity. In some cases, the UE may buffer the downlink channel measurements for the time period (e.g., 10 ms or 20 ms) after a slot in which the CMRs were received from the network entity. The downlink channel measurements may be associated with different times (or the different time instances). For example, the downlink channel measurements may include first downlink channel measurements associated with a first time instance, second downlink channel measurements associated with a second time instance, and third downlink channel measurements associated with a third time instance, where each of the first, second, and third downlink channel measurements may be associated with different CMRs indicated by the configuration. The UE may buffer the downlink channel measurements for the time period in case the downlink channel measurements need to be transmitted to the network entity.

As shown by reference number 708, the UE may transmit, to the network entity, at least a portion of the downlink channel measurements associated with the one or more time instances. At least a portion of the downlink channel measurements buffered at the UE may be transmitted to the network entity. The network entity may use the downlink channel measurements to evaluate a performance of an AI/ML model residing at the UE, where the AI/ML model may be used by the UE for beam management. The network entity may use the downlink channel measurements to determine whether the predicted future downlink channel measurements are associated with inference errors.

As an example, based at least in part on the configuration that indicates the CMRs, the UE may determine first L1-RSRP/SINR measurements at a first time, second L1-RSRP/SINR measurements at a second time, and third L1-RSRP/SINR measurements at a third time. The UE may report some measurements (e.g., strongest measurements) of the first, second, and third L1-RSRP/SINR measurements to the network entity. The UE may buffer all of the first, second, and third L1-RSRP/SINR measurements at the UE. The UE may provide the first, second, and third L1-RSRP/SINR measurements as an input to an AI/ML model running at the UE, and the AI/ML model may produce predicted future L1-RSRP/SINR measurements and/or predicted candidate beams as an output. The UE may transmit an indication of the predicted future L1-RSRP/SINR measurements and/or the predicted candidate beams to the network entity. The network entity may predict that the predicted future L1-RSRP/SINR measurements and/or the predicted candidate beams are associated with inference errors. The UE may transmit all of the first, second, and third L1-RSRP/SINR measurements to the network entity, which may include remaining measurements from the first, second, and third L1-RSRP/SINR measurements that were previously not transmitted to the network entity. The remaining measurements from the first, second, and third L1-RSRP/SINR measurements may enable the network entity to evaluate an accuracy and/or performance of the AI/ML model running at the UE. In past approaches, the remaining measurements from the first, second, and third L1-RSRP/SINR measurements would be discarded by the UE (e.g., not buffered at the UE) and would not be transmitted to the network entity. Here, the remaining measurements from the first, second, and third L1-RSRP/SINR measurements may be useful to the network entity for evaluating the accuracy and/or the performance of the AI/ML model.

As another example, based at least in part on the configuration that indicates the CMRs, the UE may determine the first L1-RSRP/SINR measurements at the first time. The UE may report some measurements (e.g., strongest measurements) of the first L1-RSRP/SINR measurements to the network entity. When the UE determines the second L1-RSRP/SINR measurements at the second time, the UE may still store the first L1-RSRP/SINR measurements. Similarly, when the UE determines the third L1-RSRP/SINR measurements at the third time, the UE may still store the first and second L1-RSRP/SINR measurements. At an end of a time period, the UE may discard the first, second, and third L1-RSRP/SINR measurements from the buffer of the UE, regardless of whether or not the UE transmits the first, second, and third L1-RSRP/SINR measurements to the network entity.

In some aspects, the UE may receive, from the network entity, a request for the downlink channel measurements buffered at the UE. The UE may transmit, to the network entity, the downlink channel measurements based at least in part on the request received from the network entity. In other words, the UE may feed back the downlink channel measurements to the network entity based at least in part on the request received from the network entity. The network entity may determine that the predicted future downlink channel measurements are potentially associated with inference errors, and as a result, the network entity may transmit the request to the UE. In some aspects, the UE may be requested by the network entity to feed back the downlink channel measurements before an expiry of the time period. When the UE is not requested to feed back the downlink channel measurements before the expiry of the time period, the downlink channel measurements may be discarded from the UE after the time period expires.

In some aspects, the network entity may transmit, to the UE, the request for the downlink measurements. The request may indicate a quantity of consecutive measurement occasions associated with the CMRs, which may be used for the downlink channel measurements. The request may indicate CMR identifiers (IDs) associated with the CMRs. The request may indicate a time period associated with the downlink channel measurements.

In some aspects, the UE may transmit a UE capability report to the network entity, where the UE capability report may indicate UE capabilities associated with downlink channel measurement buffering. In some aspects, the UE capability report may indicate, when the CMRs are included in a periodic CMR set or a semi-persistent CMR set, a maximum quantity of consecutive measurement occasions associated with the CMRs that the UE is able to buffer at the UE. The maximum quantity of consecutive measurement occasions associated with the CMRs may vary for different types of downlink channel characteristics. The maximum quantity of consecutive measurement occasions may be useful for time domain beam prediction (e.g., a time series may be used to predict future beam qualities). In some aspects, the UE capability report may indicate a maximum quantity of CMRs that the UE is able to buffer at the UE. The maximum quantity of CMRs may vary for different types of downlink channel characteristics. In some aspects, the UE capability report may indicate a maximum quantity of slots, symbols, or absolute time units (e.g., ms) that the UE is able to buffer at the UE. The maximum quantity of slots, symbols, or absolute time units may vary for different types of downlink channel characteristics.

In some aspects, the maximum quantity of consecutive measurement occasions may depend on the maximum quantity of CMRs and/or the maximum quantity of slots, symbols, or absolute time units. The maximum quantity of CMRs may depend on the maximum quantity of consecutive measurement occasions and/or the maximum quantity of slots, symbols, or absolute time units. The maximum quantity of slots, symbols, or absolute time units may depend on the maximum quantity of consecutive measurement occasions and/or the maximum quantity of CMRs.

In some aspects, the request from the network entity may be based at least in part on the UE capability report (e.g., the UE reported capabilities). The UE may not expect the network entity to request downlink channel measurement results beyond the UE reported capabilities. For example, the UE may not expect to be requested by the network entity to transmit downlink channel measurement results from over 10 ms ago, when the UE reported that only 10 ms of downlink channel measurement results can be buffered at the UE.

In some aspects, the UE may proactively request to feed back the buffered downlink channel measurements. The UE may transmit the request, to the network entity, to feed back the downlink channel measurements associated with the CMRs (e.g., the downlink channel characteristics measured from the CMRs). The UE may transmit the request based at least in part on a single bit indicator in a channel state information (CSI) report associated with reporting predicted channel characteristics. The UE may protectively transmit the request based at least in part on a dedicated scheduling request (SR) or a MAC-CE. In this case, the UE may determine that the predicted future downlink channel measurements are potentially associated with inference errors or that inference errors are likely to occur, so the UE may request to transmit the buffered downlink channel measurements to enable the network entity to perform a troubleshooting regarding an accuracy of the predicted future downlink channel measurements.

In some aspects, the UE may transmit the request, to the network entity, to feed back the downlink channel measurements associated with the CMRs based at least in part on the UE being configured to predict time domain and/or spatial domain channel characteristics associated with the CMRs, and based at least in part on the UE identifying that measured channel characteristics and predicted channel characteristics are different. For time domain prediction, downlink channel measurements based at least in part on the CMRs or additionally other CMRs and/or DMRSs may be used as inputs to predict future channel characteristics associated with the CMRs. For spatial domain prediction, downlink channel measurements based at least in part on the other CMRs and/or DMRSs may be used as inputs to predict channel characteristics associated with the CMRs.

In some aspects, the UE may transmit the request, to the network entity, based at least in part on a difference between the measured channel characteristics and the predicted channel characteristics satisfying a threshold (e.g., the difference may be beyond a certain threshold). The threshold may be standard predefined and/or may be preconfigured by the network entity. The threshold may be defined or configured differently for different types of channel characteristics. For example, the threshold may be configured by a CSI report setting for reporting the predicted channel characteristics. In some aspects, the UE may determine that the predicted future downlink channel measurements (e.g., predicted channel characteristics) do not correspond with actual downlink channel measurements (e.g., measured channel characteristics). In this case, the UE may transmit the request to the network entity.

In some aspects, the UE may transmit the request, to the network entity, to feed back the downlink channel measurements associated with the CMRs. The request may indicate the quantity of consecutive measurement occasions associated with the CMRs, which may be used for the downlink channel measurements. The request may indicate the CMR IDs associated with the CMRs. The request may indicate the time period associated with the downlink channel measurements. In other words, when the UE transmits the request for transmitting the buffered downlink channel measurements instead of the network entity, the UE may report the quantity of consecutive measurement occasions associated with the CMRs, the CMR IDs associated with the CMRs, and/or the time period associated with the downlink channel measurements.

In some aspects, the downlink channel measurements may be associated with an aperiodic channel state information (AP-CSI) measurement reporting. For example, the UE may be triggered with an AP-CSI report with 64 CMRs. The UE may report, via an AP-CSI report, the two strongest L1-RSRP measurements associated with two CMRs out of the 64 CMRs. The AP-CSI report may not necessarily be associated with multiple occasions (or time instances), but rather may be associated with a single occasion (single time instance). Conventionally, the UE is not expected to be requested to report information regarding the two strongest L1-RSRP measurements (or even more L1-RSRP measurements associated with other beams) at a later time. However, in this case, the UE may be requested by the network entity to report such information at the later time (e.g., 10 ms later). The network entity may request the UE, or the UE may send the request to the network entity, to transmit the information regarding the two strongest L1-RSRP measurements and/or information regarding the other 62 L1-RSRP measurements (or a smaller subset of the 62 L1-RSRP measurements) to the network entity. The UE may store (e.g., in a buffer of the UE) information regarding all L1-RSRP measurements associated with the 64 CMRs for a period of time, and after an expiry of the period of time, the UE may discard this information.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with storing downlink channel measurements associated with one or more time instances at a UE.

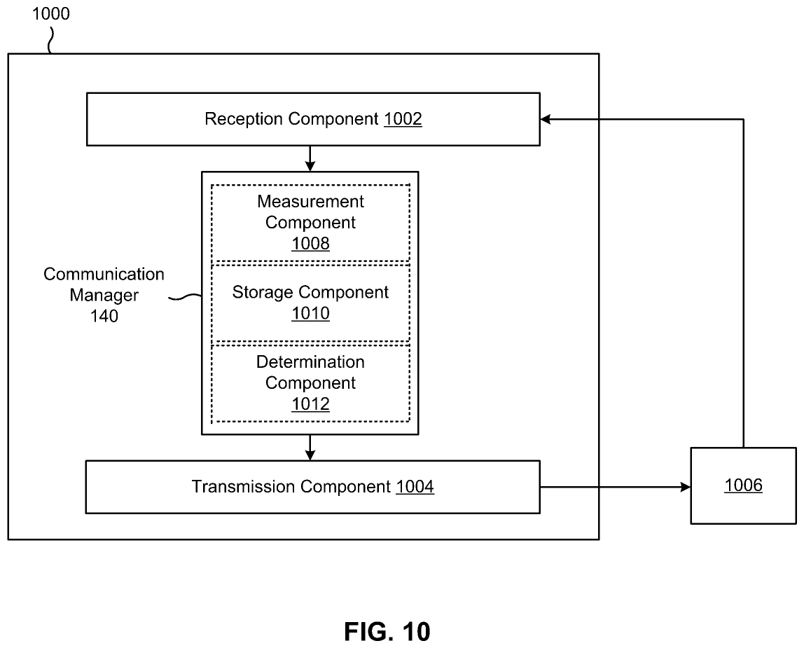

As shown in FIG. 8, in some aspects, process 800 may include receiving, from a network entity, a configuration associated with CMRs (block 810). For example, the UE (e.g., using communication manager 140 and/or reception component 1002, depicted in FIG. 10) may receive, from a network entity, a configuration associated with CMRs, as described above.

As further shown in FIG. 8, in some aspects, process 800 may include performing downlink channel measurements associated with the CMRs, wherein the downlink channel measurements are associated with one or more time instances (block 820). For example, the UE (e.g., using communication manager 140 and/or measurement component 1008, depicted in FIG. 10) may perform downlink channel measurements associated with the CMRs, wherein the downlink channel measurements are associated with one or more time instances, as described above.

As further shown in FIG. 8, in some aspects, process 800 may include storing the downlink channel measurements associated with the one or more time instances for a period of time at the UE (block 830). For example, the UE (e.g., using communication manager 140 and/or storage component 1010, depicted in FIG. 10) may store the downlink channel measurements associated with the one or more time instances for a period of time at the UE, as described above.

As further shown in FIG. 8, in some aspects, process 800 may include transmitting, to the network entity and based at least in part on a request, at least a portion of the downlink channel measurements associated with the one or more time instances (block 840). For example, the UE (e.g., using communication manager 140 and/or transmission component 1004, depicted in FIG. 10) may transmit, to the network entity and based at least in part on a request, at least a portion of the downlink channel measurements associated with the one or more time instances, as described above.

Process 800 may include additional aspects, such as any single aspect or any combination of aspects described below and/or in connection with one or more other processes described elsewhere herein.

In a first aspect, process 800 includes receiving, from the network entity and prior to an expiry of the period of time, the request for transmitting at least the portion of the downlink channel measurements.

In a second aspect, alone or in combination with the first aspect, process 800 includes transmitting, to the network entity and prior to an expiry of the period of time, the request for transmitting at least the portion of the downlink channel measurements.

In a third aspect, alone or in combination with one or more of the first and second aspects, the request indicates one or more of a quantity of consecutive measurement occasions associated with the CMRs for the downlink channel measurements, CMR identifiers associated with the CMRs for the downlink channel measurements, or the time period associated with the downlink channel measurements.

In a fourth aspect, alone or in combination with one or more of the first through third aspects, process 800 includes transmitting, to the network entity, a UE capability report, wherein at least the portion of the downlink channel measurements is transmitted to the network entity based at least in part on the UE capability report.

In a fifth aspect, alone or in combination with one or more of the first through fourth aspects, the UE capability report indicates one or more of a maximum quantity of consecutive measurement occasions associated with the CMRs that the UE is able to store, a maximum quantity of CMRs associated with a set of CMRs that the UE is able to store, or a maximum quantity of slots, symbols, or absolute time units that the UE is able to store.

In a sixth aspect, alone or in combination with one or more of the first through fifth aspects, process 800 includes discarding the downlink channel measurements after an expiry of the period of time.

In a seventh aspect, alone or in combination with one or more of the first through sixth aspects, process 800 includes determining predicted future downlink channel measurements based at least in part on the downlink channel measurements, and transmitting, to the network entity, the predicted future downlink channel measurements.

In an eighth aspect, alone or in combination with one or more of the first through seventh aspects, process 800 includes determining that a difference between additional downlink channel measurements and the predicted future downlink channel measurements satisfies a threshold; and transmitting, to the network entity and based at least in part on the difference satisfying the threshold, the request for transmitting at least the portion of the downlink channel measurements.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network entity, in accordance with the present disclosure. Example process 900 is an example where the network entity (e.g., base station 110) performs operations associated with storing downlink channel measurements associated with one or more time instances at a UE.

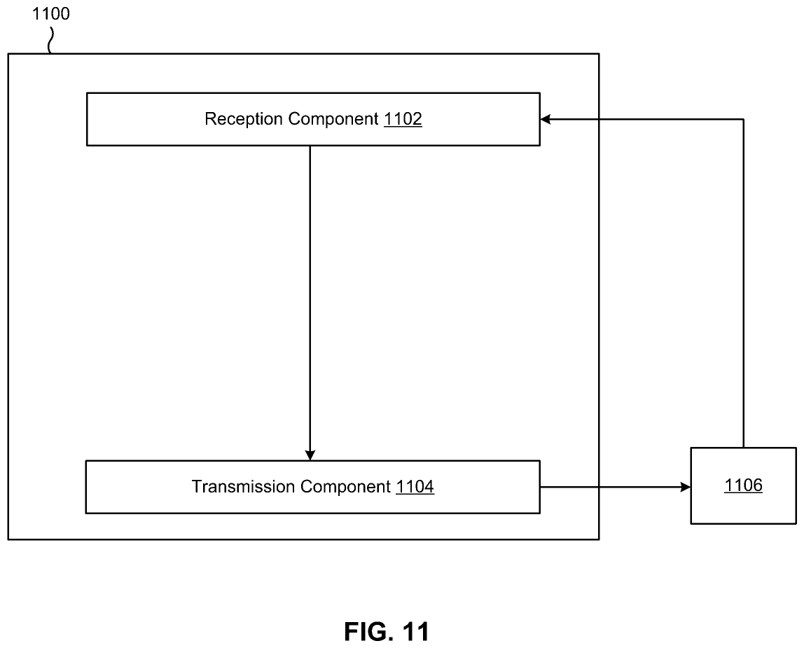

As shown in FIG. 9, in some aspects, process 900 may include transmitting, to a UE, a configuration associated with CMRs (block 910). For example, the network entity (e.g., using transmission component 1104, depicted in FIG. 11) may transmit, to a UE, a configuration associated with CMRs, as described above.

As further shown in FIG. 9, in some aspects, process 900 may include receiving, from the UE and based at least in part on a request, at least a portion of downlink channel measurements stored for a period of time at the UE, wherein the downlink channel measurements are associated with the CMRs and with one or more time instances (block 920). For example, the network entity (e.g., using reception component 1102, depicted in FIG. 11) may receive, from the UE and based at least in part on a request, at least a portion of downlink channel measurements stored for a period of time at the UE, wherein the downlink channel measurements are associated with the CMRs and with one or more time instances, as described above.

Process 900 may include additional aspects, such as any single aspect or any combination of aspects described below and/or in connection with one or more other processes described elsewhere herein.

In a first aspect, process 900 includes transmitting, to the UE and prior to an expiry of the period of time, the request for transmitting at least the portion of the downlink channel measurements.

In a second aspect, alone or in combination with the first aspect, process 900 includes receiving, from the UE and prior to an expiry of the period of time, the request for transmitting at least the portion of the downlink channel measurements.

In a third aspect, alone or in combination with one or more of the first and second aspects, process 900 includes receiving, from the UE, a UE capability report, wherein at least the portion of the downlink channel measurements is based at least in part on the UE capability report.

In a fourth aspect, alone or in combination with one or more of the first through third aspects, process 900 includes receiving, from the UE, predicted future downlink channel measurements, wherein the predicted future downlink channel measurements are based at least in part on the downlink channel measurements; and receiving, from the UE and based at least in part on a difference between additional downlink channel measurements and the predicted future downlink channel measurements satisfying a threshold, the request for transmitting at least the portion of the downlink channel measurements.

In a fifth aspect, alone or in combination with one or more of the first through fourth aspects, at least the portion of the downlink channel measurements is associated with an AP-CSI measurement reporting.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include one or more of a measurement component 1008, a storage component 1010, or a determination component 1012, among other examples.

In some aspects, the apparatus 1000 may be configured to perform one or more operations described herein in connection with FIG. 7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive, from a network entity, a configuration associated with CMRs. The measurement component 1008 may perform downlink channel measurements associated with the CMRs, wherein the downlink channel measurements are associated with one or more time instances. The storage component 1010 may store the downlink channel measurements associated with the one or more time instances for a period of time at the UE. The transmission component 1004 may transmit, to the network entity and based at least in part on a request, at least a portion of the downlink channel measurements associated with the one or more time instances.

The reception component 1002 may receive, from the network entity and prior to an expiry of the period of time, the request for transmitting at least the portion of the downlink channel measurements. The transmission component 1004 may transmit, to the network entity and prior to an expiry of the period of time, the request for transmitting at least the portion of the downlink channel measurements. The transmission component 1004 may transmit, to the network entity, a UE capability report, wherein at least the portion of the downlink channel measurements is transmitted to the network entity based at least in part on the UE capability report. The storage component 1010 may discard the downlink channel measurements after an expiry of the period of time.

The determination component 1012 may determine predicted future downlink channel measurements based at least in part on the downlink channel measurements. The transmission component 1004 may transmit, to the network entity, the predicted future downlink channel measurements. The determination component 1012 may determine that a difference between additional downlink channel measurements and the predicted future downlink channel measurements satisfies a threshold. The transmission component 1004 may transmit, to the network entity and based at least in part on the difference satisfying the threshold, the request for transmitting at least the portion of the downlink channel measurements.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a network entity, or a network entity may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104.

In some aspects, the apparatus 1100 may be configured to perform one or more operations described herein in connection with FIG. 7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network entity described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network entity described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network entity described in connection with FIG. 2. In some aspects, the transmission component 1104 may be co-located with the reception component 1102 in a transceiver.

The transmission component 1104 may transmit, to a UE, a configuration associated with CMRs. The reception component 1102 may receive, from the UE and based at least in part on a request, at least a portion of downlink channel measurements stored for a period of time at the UE, wherein the downlink channel measurements are associated with the CMRs and with one or more time instances.

The transmission component 1104 may transmit, to the UE and prior to an expiry of the period of time, the request for transmitting at least the portion of the downlink channel measurements. The reception component 1102 may receive, from the UE and prior to an expiry of the period of time, the request for transmitting at least the portion of the downlink channel measurements. The reception component 1102 may receive, from the UE, a UE capability report, wherein at least the portion of the downlink channel measurements is based at least in part on the UE capability report. The reception component 1102 may receive, from the UE, predicted future downlink channel measurements, wherein the predicted future downlink channel measurements are based at least in part on the downlink channel measurements. The reception component 1102 may receive, from the UE and based at least in part on a difference between additional downlink channel measurements and the predicted future downlink channel measurements satisfying a threshold, the request for transmitting at least the portion of the downlink channel measurements.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

### Retransmission of CSI Report for ML Based Prediction

Understanding the channel state between devices communicating in a wireless communications system is an important aspect of improving the performance of wireless communications. Conventionally, many techniques have been employed for measuring the channel state and reporting feedback so that performance can be improved. However, such conventional techniques are often relatively slow, power hungry, and static in approach.

ML represents an opportunity to improve upon many conventional techniques for measuring channel state and reporting feedback. For example, machine learning models may reduce the number of resource elements needed for estimating a channel state, and improve the estimates of values used in reporting the channel state. However, ML-based beam prediction typically relies on user equipment (UE) reported measurement values. An ML-based beam prediction algorithm may take a time series of such reported measurements and output a prediction for a future time window, such as a predicted beam change.

Unfortunately, missing one or more of the UE measurements may be unavoidable under certain conditions. Missing measurement reports may cause error propagation which could result in inaccurate time domain (TD) beam prediction. As an example, input samples associated with the missing reporting occasions may have to be replaced by the most recently available reported samples (which may no longer accurately reflect current channel conditions). Thus, such replacement may lead to beam prediction errors.

To help address such missing measurement reporting problems, aspects of the present disclosure propose techniques whereby certain information may be retransmitted, for example, when the occurrence of a missing measurement report is detected. As will be described in greater detail below, a UE may be configured to buffer certain measurement information associated with periodic measurement reports so that, in the event a measurement report is missed, it may retransmit the information. As a result, missing measurement information may be provided to an ML-based beam prediction model, which may lead to more accurate prediction results.

Thus, aspects described herein, which enable robust use of machine learning models for channel state measuring and feedback procedures, enhance wireless communications performance generally, and more specifically through reduced power use, increased battery life, improved spectral efficiency, reduced latency, and decreased network overhead, to name a few technical improvements.

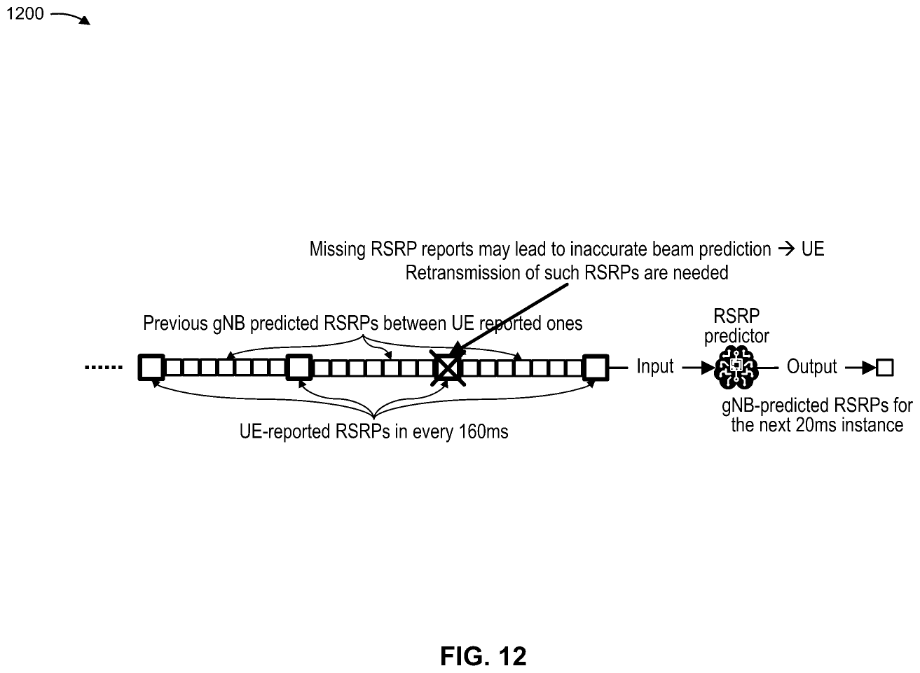

FIG. 12 is a diagram illustrating an example 1200 associated with missing CSI reports, in accordance with the present disclosure.

ML-based beam prediction typically relies on UE reported measurement values. For example, as shown in FIG. 12, an ML-based algorithm may perform beam prediction based on periodically reported (e.g., every 160 ms) RSRP measurements. In the illustrated example, the ML model may predict RSRPs (e.g., for the next 20 ms instance) based on the series of RSRP measurements reports.

In RSRP reports are missing, the ML-based algorithm may use previous predicted (or previously reported) RSRPs to fill in the missing report information. Unfortunately, using the predicted RSRP to replace the missing RSRP reported values may lead to inaccurate beam prediction.

To help address such missing measurement reporting problems, aspects of the present disclosure propose techniques whereby certain information may be retransmitted, for example, when the occurrence of a missing measurement report is detected. Aspects of the present disclosure provide detailed UE capability definitions and signaling enhancements, that may help support retransmission of L1-reports, for network node based and ML-assisted time domain beam prediction. As will be described in greater detail below, a UE may be configured to buffer certain measurement information associated with periodic measurement reports so that, in the event a measurement report is missed, it may retransmit the information.

As indicated above, FIG. 12 is provided as an example. Other examples may differ from what is described with regard to FIG. 12.

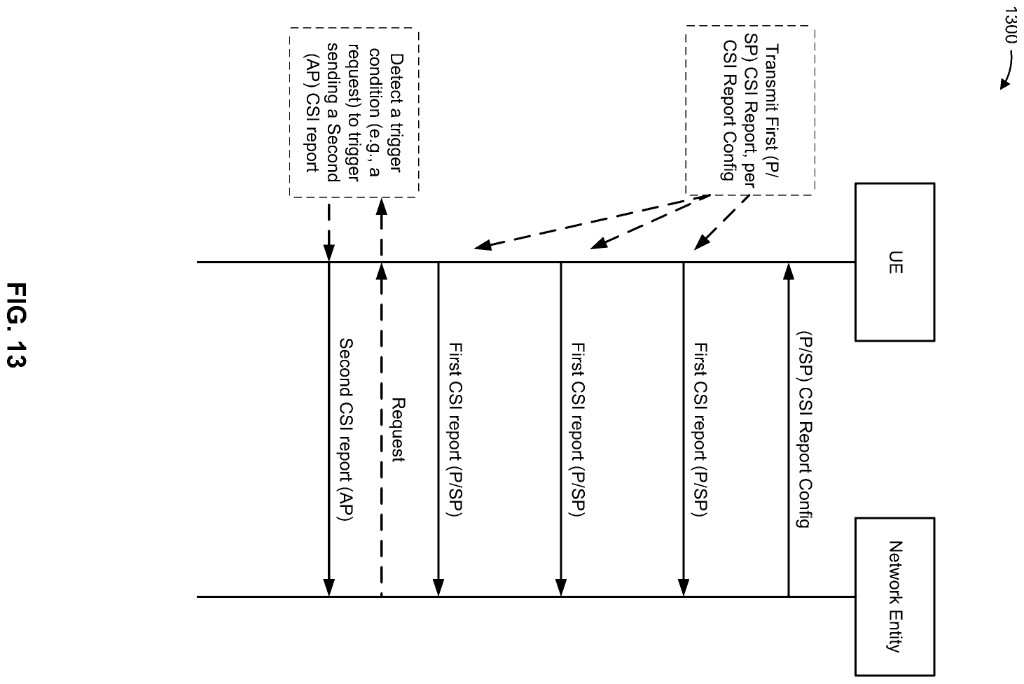

FIG. 13 is a diagram illustrating an example 1300 associated with retransmitting CSI information, in accordance with the present disclosure.

As shown in FIG. 13, in a measurement report retransmission, a UE may first be configured (by a network entity) for periodic (P) or semi-persistent (SP) CSI reporting. For example, the UE may be configured to report SSB rank indicator (SSBRI), CSI resource indicator (CRI) and L1-RSRP/L1-signal to interference and noise ratio (L1-SINR) information, via CSI reports. The UE may then periodically transmit a first CSI report, based on the configuration. In response to detecting a trigger condition, the UE may transmit an aperiodic (AP) second CSI report. For example, the condition may be receipt of a request for AP reporting from the network or the condition may be based on a triggering event associated with a CSI-RS resource configuration.

As indicated above, FIG. 13 is provided as an example. Other examples may differ from what is described with regard to FIG. 13.

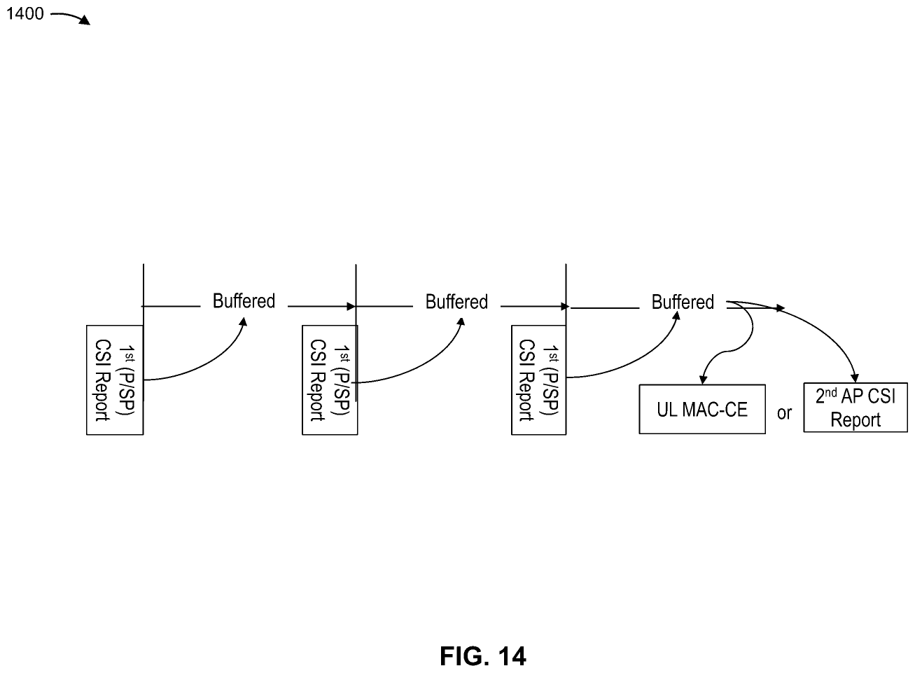

FIG. 14 is a diagram illustrating an example 1400 associated with buffering and retransmission of L1-reports for ML based TD beam prediction, in accordance with the present disclosure.

As shown in FIG. 14, in some cases, in order to support retransmission of certain information, the UE may buffer one or more components of report quantities (e.g., one or more channel characteristic measurements associated with the first P/SP CSI report) associated with a most recently reported first CSI report, until a certain first time instance after transmitting the first CSI report. After transmitting the first CSI report and until the first time instance, the UE can be further triggered with a second AP CSI report, or requested to report via uplink MAC-CE, a retransmission of the buffered report quantities.

Possible report quantities (that may be part of the AP reporting) may include L1-RSRPs/SINRs and their associated connection-management-request IDs and other report quantities like RI/PMI/CQI. In some cases, a priority of the second (AP) reporting may be lower than other types of CSI reports e.g., (as the other ones may impact more instantaneous communication performance).

In some cases, the UE may only buffer measurement information after the UE reported its capability to perform such buffering. The UE may indicate such capabilities explicitly or implicitly.

As indicated above, FIG. 14 is provided as an example. Other examples may differ from what is described with regard to FIG. 14.

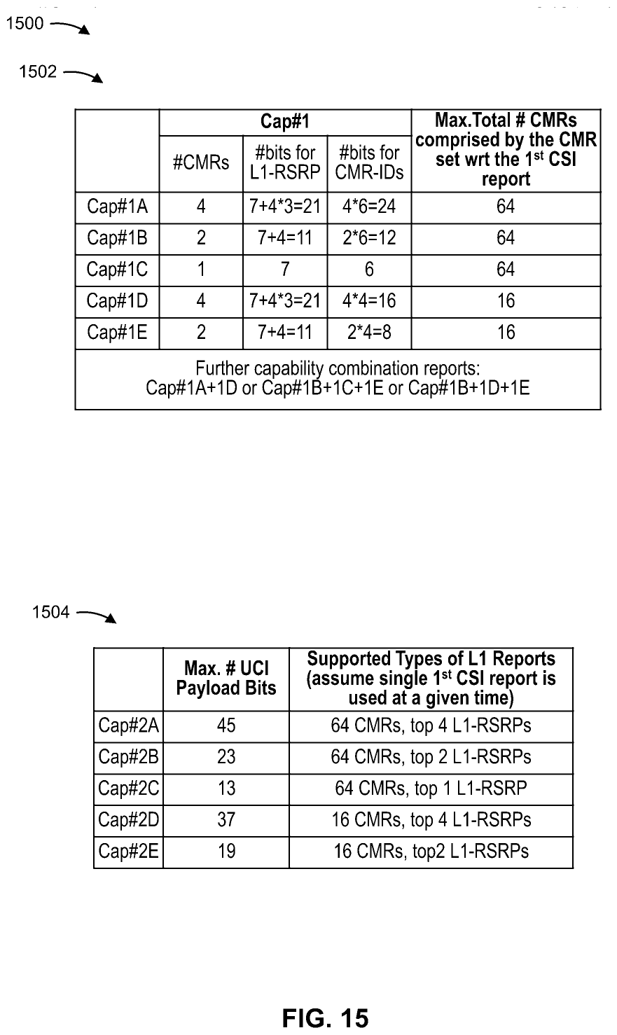

FIG. 15 is a diagram illustrating an example 1500 associated with tables describing explicitly reported UE capabilities, in accordance with the present disclosure.

For explicit UE capability reporting, the UE may report according to one or more options. For example, according to a first option, the UE may report a maximum number of L1-RSRPs/SINRs (together with their associated CMR IDs) that can be buffered from the first CSI report. As shown by reference number 1502, a table illustrates example of how a UE may report capabilities by indicating a row in a configuration table.

The reported maximum number may be further dependent on the maximum total number of CMRs included in the CMR set associated with the first CSI report, since a greater number of bits are needed to report CRI/SSBRI for greater number of CSI-RS/SSB resources. In some cases, the UE may further report multiple combinations of such capabilities, each combination indicating that the buffer can be simultaneously shared among the associated multiple active first CSI reports.

According to a second option, the UE may report one or multiple options of maximum number of buffered UCI payload bits. For example, as shown by reference number 1504, the UE may indicate the maximum number of UCI payload bits the UE may buffer, for certain types of reports or combination of report types. In some cases, the buffered UCI payload bits are shared among multiple active first CSI reports.

One example of implicit UE capability reporting is via a reported number of CSI processing units (CPUs) the UE supports. For example, the UE may implicitly indicate the number of UCI bits it can buffer via a UE capability report that indicates a maximum number of CPUs the UE supports. In some cases, a certain number of maximum UCI payload bits that can be buffered at a certain time, is standard predefined to be associated with a single CPU. For example, a single CPU can be defined as buffering up to 45 UCI bits at a given time.

As indicated above, FIG. 15 is provided as an example. Other examples may differ from what is described with regard to FIG. 15.

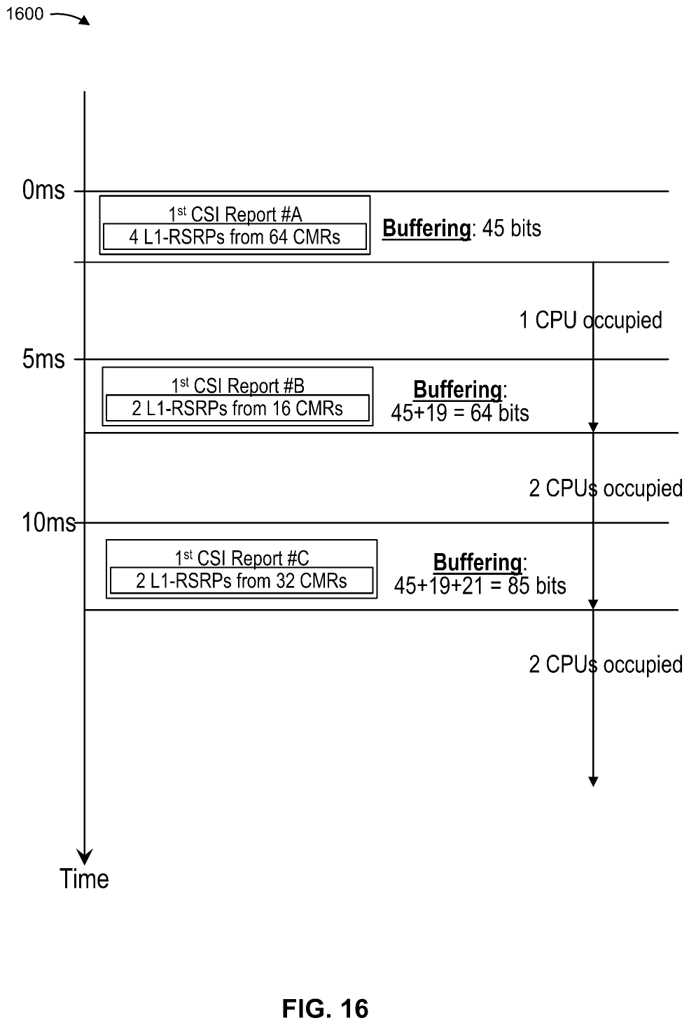

FIG. 16 is a diagram illustrating an example 1600 associated with a timeline associated with implicit UE capability reporting via CPUs, in accordance with the present disclosure.

The UE reports a certain number of CPUs, representing its capability to buffer UCI payloads, wherein reporting multiple number of CPUs represents an extended number of UCI payload bits for the same duration. For example, as shown in FIG. 16, suppose a single CPU can be defined to occupy 45 payload bits to buffer at a certain time, UE reporting two CPUs represents that it can buffer up to 90 UCI payload bits at a given time. In some cases, the number of UCI bits may be rounded up to the applicable number matching integer number of CPUs is considered when calculating occupied number of CPUs.

According to a first option, as shown in FIG. 16, the UE may be considered as occupying an additional number of CPUs after the first CSI Report. Such a number of CPUs may only be occupied after the UE reported the first CSI report. According to a second option, the additional number of CPUs may be occupied with a TD offset before the slot transmitting the first CSI report. This may make sense because the UE may need to buffer the UCI payload bits before transmitting them for the first time. The offset can be standard predefined, or further reported as UE capability.

According to certain aspects, when to maintain or clear buffered UCI bits may depend on priorities between multiple first CSI reports (e.g., wither first-in-first-out). If the simultaneously required number of bits (to buffer) is greater than the UE reported capability, the UE may clear the earliest buffered ones (e.g., effectively prioritizing the most recent first CSI report when buffering).

In some cases, these two types of capability reporting may be combined. For example, instead of predefining the number of UCI payload bits by standard, the number of UCI payload bits associated with a single CPU may be UE reported. Based on this association, the buffering capability may be implicitly indicated by indicating the number of CSI processing units (CPUs) the UE supports, assuming each CPU is associated with a number of UCI bits.

The UE may apply various buffer release and/or replacement rules when determining what UCI bits to buffer or clear. Buffered UCI payload bits regarding a certain first CSI report can be released, based on various techniques.

As indicated above, FIG. 16 is provided as an example. Other examples may differ from what is described with regard to FIG. 16.

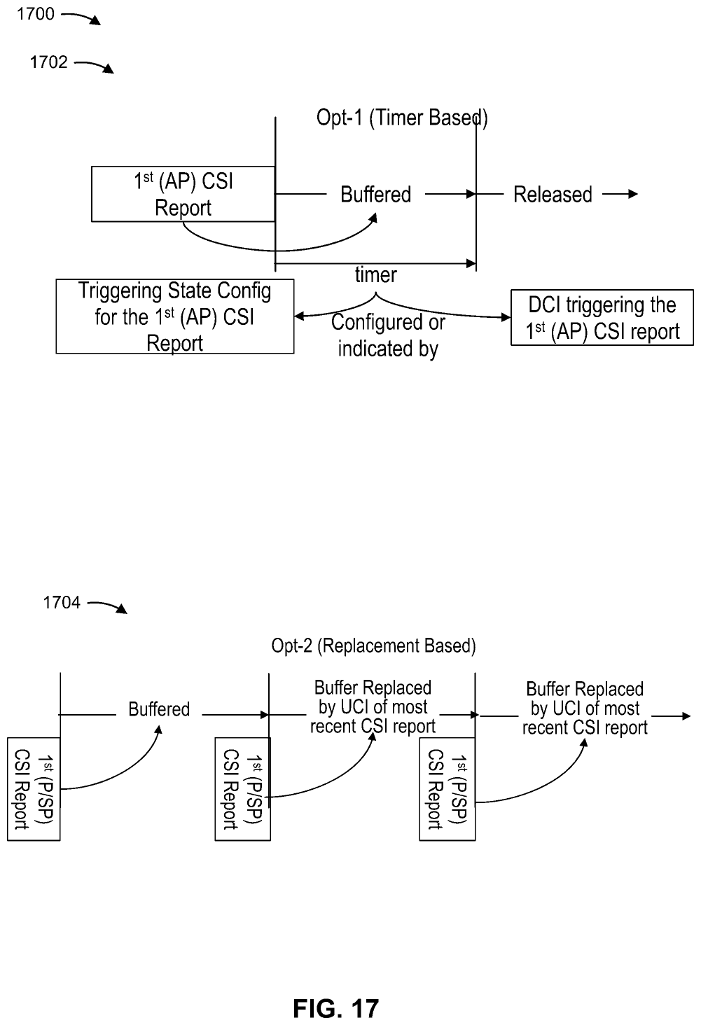

FIG. 17 is a diagram illustrating an example 1700 associated with options for buffer release and replacement, in accordance with the present disclosure.

As shown by reference number 1702, using a timer-based technique, the buffered UCI payload bits can be released, after a time starting after the associated first CSI report is initially transmitted, has expired. The timer length can be standard predefined, or further network node configured together with the triggering state configurations associated with the first (AP) CSI report, or dynamically indicated when triggering the first (AP) CSI report. For example, when the first CSI report is an AP CSI report, the buffered UCI payload bits can be released after 5 slots.

According to a second option, as shown by reference number 1704, buffered bits may be replaced by a new CSI report's payload in a series of P/SP CSI reports. For example, the first CSI report may be associated with a P/SP CSI report setting, such that the buffered UCI payload bits are replaced by the UCI payload bits of the same series of P/SP CSI reports, after a next applicable first CSI report is transmitted.

As indicated above, FIG. 17 is provided as an example. Other examples may differ from what is described with regard to FIG. 17.

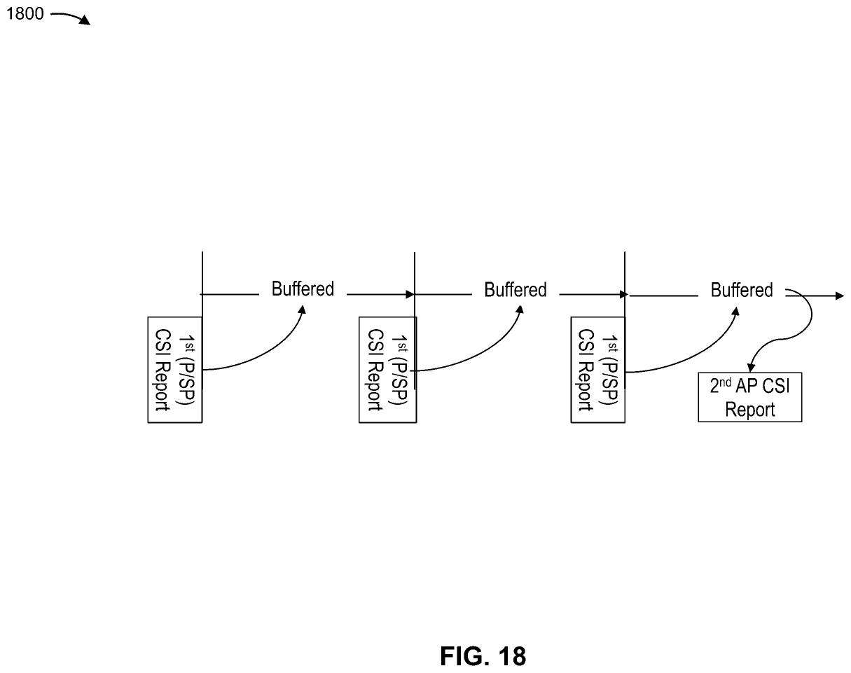

FIG. 18 is a diagram illustrating an example 1800 associated with triggering a second AP CSI report, in accordance with the present disclosure.

As shown in FIG. 18, the second AP CSI report may be triggered and may include information from a previous P/SP CSI report. There are various options for triggering the second AP CSI Report. For example, in some cases, the UE may be further configured with an AP CSI report triggering state configuration associated with the second AP CSI report, comprising at least one of the following enhancement information: an ID of the CSI report setting associated with the first CSI report and a number of L1-RSRPs/SINRs that should be buffered. For example, to reduce buffering efforts, although the first CSI report may need to report 4 L1-RSRPs together with the CMR-IDs, the second AP CSI report may only need to report the strongest one/two. A buffer release timer, as described above, may also be used. Such configurations may be via the CSI-AssociatedReportConfigInfo IE associated with the triggering state configuration of the second AP CSI report.

In some cases, upon receiving an uplink-grant DCI triggering the second AP CSI report, the UE may report the UCI payloads most recently reported by the first CSI report. The network may try and make sure that the second AP CSI report should not be reported at a time where the associated UCI payloads are already released. In some cases, if the UE receives the uplink-grant before the associated timer expires, the UE may reset the timer after the second CSI report is successfully transmitted. In this manner, if the second CSI report is also missed, the network node can further trigger another second CSI report.

As indicated above, FIG. 18 is provided as an example. Other examples may differ from what is described with regard to FIG. 18.

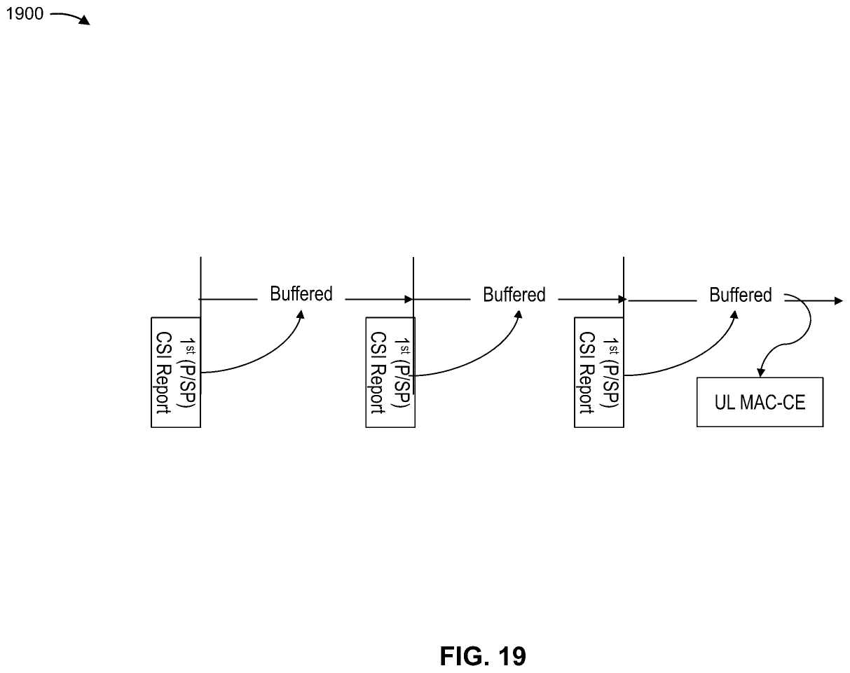

FIG. 19 is a diagram illustrating an example 1900 associated with a MAC-CE based UCI retransmission, in accordance with the present disclosure.

As shown in FIG. 19, in some cases, buffered measurements may be transmitted via a MAC-CE based UCI retransmission. Such buffered UCI payloads may be alternatively reported via uplink MAC-CE. This may be further based on, for example, the buffering configurations described above, which may be configured alternatively by the CSI report setting associated with the first CSI report. In some cases, an uplink MAC-CE can be requested by the network node via MAC-CE/DCI. The request may include the first CSI report's report setting ID.

When the UE receives the network node commands on transmitting such uplink MAC-CE before the associated timer expires, the UE may reset the timer after the MAC-CE is successfully transmitted. Such that if the MAC-CE is also missed, the network node can further trigger another second CSI report or request another MAC-CE.

As indicated above, FIG. 19 is provided as an example. Other examples may differ from what is described with regard to FIG. 19.

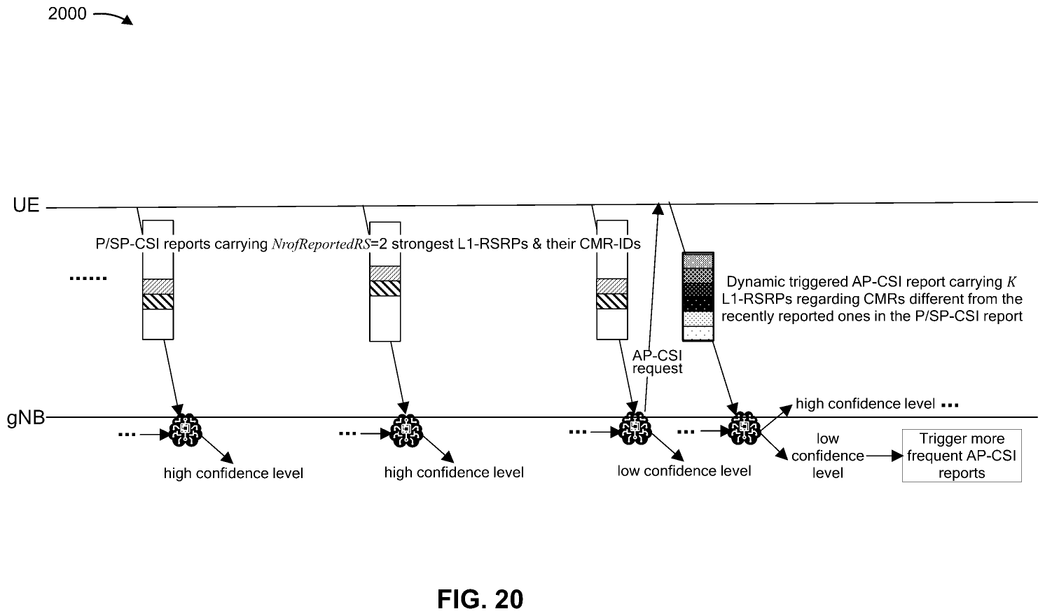

FIG. 20 is a diagram illustrating an example 2000 associated with reporting additional CSI information, in accordance with the present disclosure.

As shown in FIG. 20, in some cases, the techniques described herein may be extended to reporting additional L1-RSRPs/SINRs (e.g., measurement for different CMRs than associated with the first P/SP CSI report transmissions. In such cases, the report quantities in the second CSI report may alternatively be additional L1-RSRPs that have not been reported in the first CSI report. This approach may help remove prediction uncertainty with marginal additional reporting efforts. Similar buffering capabilities and buffer release rules, as described above, may be extended to such use cases.

In some cases, the UE capabilities reported, as described above, may be reported for any activated serving cell (ServCell). For example, this may imply that different component carriers (CCs) may have their own buffer memory (allocation at the UE). In other cases, the UE capabilities reported, as described above, may be reported as a shared capability among multiple ServCells (e.g., FR1 and FR2 CCs may need to share a common buffer memory).

As indicated above, FIG. 20 is provided as an example. Other examples may differ from what is described with regard to FIG. 20.

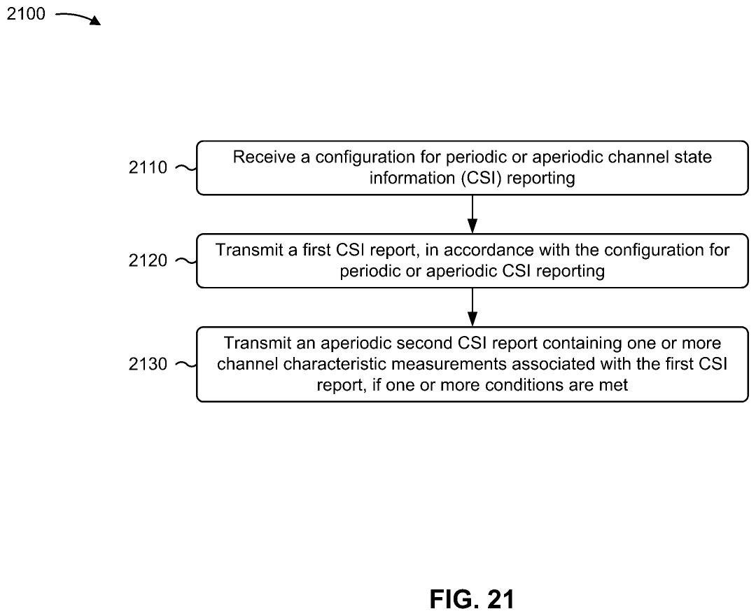

FIG. 21 is a diagram illustrating an example process 2100 performed, for example, by a UE, in accordance with the present disclosure. Example process 2100 is an example where the UE (e.g., UE 120) performs operations associated with a retransmission of a CSI report for machine learning based prediction.

As shown in FIG. 21, in some aspects, process 2100 may include receiving a configuration for periodic or aperiodic CSI reporting (block 2110). For example, the UE (e.g., using communication manager 140 and/or reception component 1002, depicted in FIG. 10) may receive a configuration for periodic or aperiodic CSI reporting, as described above.

As further shown in FIG. 21, in some aspects, process 2100 may include transmitting a first CSI report, in accordance with the configuration for periodic or aperiodic CSI reporting (block 2120). For example, the UE (e.g., using communication manager 140 and/or measurement component 1008, depicted in FIG. 10) may transmit a first CSI report, in accordance with the configuration for periodic or aperiodic CSI reporting, as described above.

As further shown in FIG. 21, in some aspects, process 2100 may include transmitting an aperiodic second CSI report containing one or more channel characteristic measurements associated with the first CSI report, if one or more conditions are met (block 2130). For example, the UE (e.g., using communication manager 140 and/or storage component 1010, depicted in FIG. 10) may transmit an aperiodic second CSI report containing one or more channel characteristic measurements associated with the first CSI report, if one or more conditions are met, as described above.

Process 2100 may include additional aspects, such as any single aspect or any combination of aspects described below and/or in connection with one or more other processes described elsewhere herein.

In a first aspect, the one or more conditions are met if the UE receives a request to transmit the second CSI report.

In a second aspect, alone or in combination with the first aspect, the UE buffers the channel characteristic measurements associated with the first CSI report for a time duration after transmitting the first CSI report, and the UE expects to receive the request within the time duration.

In a third aspect, alone or in combination with one or more of the first and second aspects, the channel characteristic measurements associated with the first CSI report comprise at least one of RSRP, SINR, RI, PMI, CQI, or LI values.

In a fourth aspect, alone or in combination with one or more of the first through third aspects, the channel characteristic measurements associated with the first CSI report comprise one or more values not previously reported.

In a fifth aspect, alone or in combination with one or more of the first through fourth aspects, the aperiodic second CSI report has a lower priority than the one or more other types of CSI reports.

In a sixth aspect, alone or in combination with one or more of the first through fifth aspects, process 2100 includes reporting a capability of the UE to buffer the channel characteristic measurements associated with the first CSI report.

In a seventh aspect, alone or in combination with one or more of the first through sixth aspects, the capability is indicated as a number of UCI bits the UE can buffer at a given time.

In an eighth aspect, alone or in combination with one or more of the first through seventh aspects, the UE indicates one or more capability indexes, wherein each capability index maps to a number of UCI bits.

In a ninth aspect, alone or in combination with one or more of the first through eighth aspects, the capability is implicitly indicated by a number of CPUs the UE supports, each CPU associated with a number of UCI bits.

In a tenth aspect, alone or in combination with one or more of the first through ninth aspects, the UE occupies additional CPUs after transmitting the first CSI report while buffering the one or more report quantities.

In an eleventh aspect, alone or in combination with one or more of the first through tenth aspects, process 2100 includes clearing bits of the buffered one or more report quantities in order to avoid exceeding the number of UCI bits the UE indicated it can support, wherein the bits are cleared based on how long they have been buffered.

In a twelfth aspect, alone or in combination with one or more of the first through eleventh aspects, the capability is indicated by reporting a number of CPUs the UE supports, and a number of UCI bits the UE supports per CPU.

In a thirteenth aspect, alone or in combination with one or more of the first through twelfth aspects, the capability of the UE to buffer the channel characteristic measurements associated with the first CSI report is reported for activated serving cells.

In a fourteenth aspect, alone or in combination with one or more of the first through thirteenth aspects, the capability of the UE to buffer the channel characteristic measurements associated with the first CSI report is reported as a shared capability among multiple serving cells.

In a fifteenth aspect, alone or in combination with one or more of the first through fourteenth aspects, process 2100 includes releasing buffered bits of the channel characteristic measurements associated with the first CSI report a time period after transmission of the first CSI report.

In a sixteenth aspect, alone or in combination with one or more of the first through fifteenth aspects, process 2100 includes the first report is associated with a periodic or SP CSI report setting, and the UE released buffered bits of the channel characteristic measurements associated with the first CSI report, such that buffered UCI payload bits are replaced by UCI payload bits of a same series of periodic or SP, after a subsequent CSI report is.

In a seventeenth aspect, alone or in combination with one or more of the first through sixteenth aspects, the one or more conditions involve a report triggering state associated with a configuration of the second CSI report.

In an eighteenth aspect, alone or in combination with one or more of the first through seventeenth aspects, process 2100 includes the configuration of the second CSI report indicates an AP CSI triggering state association with the second CSI report.

In a nineteenth aspect, alone or in combination with one or more of the first through eighteenth aspects, the second CSI report is transmitted via an uplink MAC-CE.

In a twentieth aspect, alone or in combination with one or more of the first through nineteenth aspects, process 2100 includes receiving a request for the second CSI report, wherein the second CSI report is transmitted via the uplink MAC-CE in response to the request.

In a twenty-first aspect, alone or in combination with one or more of the first through twentieth aspects, the channel characteristic measurements associated with the first CSI report comprise one or more channel characteristic measurements not previously reported in the first CSI report.

Although FIG. 21 shows example blocks of process 2100, in some aspects, process 2100 may include additional blocks, fewer blocks, different blocks, or differently arranged blocks than those depicted in FIG. 21. Additionally, or alternatively, two or more of the blocks of process 2100 may be performed in parallel.

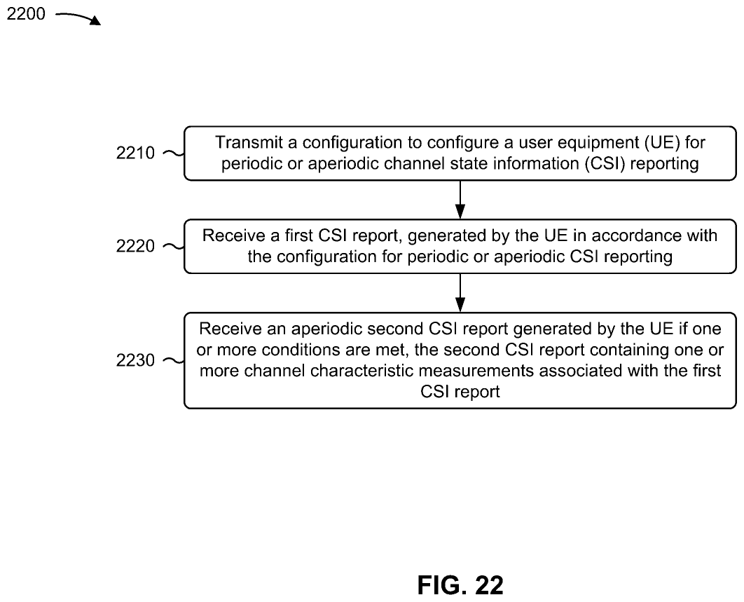

FIG. 22 is a diagram illustrating an example process 2200 performed, for example, by a UE, in accordance with the present disclosure. Example process 2200 is an example where the UE (e.g., UE 120) performs operations associated with a retransmission of a CSI report for machine learning based prediction.

As shown in FIG. 22, in some aspects, process 2200 may include transmitting a configuration to configure a UE for periodic or aperiodic CSI reporting (block 2210). For example, the UE (e.g., using communication manager 140 and/or reception component 1002, depicted in FIG. 10) may transmit a configuration to configure a UE for periodic or aperiodic CSI reporting, as described above.

As further shown in FIG. 22, in some aspects, process 2200 may include receiving a first CSI report, generated by the UE in accordance with the configuration for periodic or aperiodic CSI reporting (block 2220). For example, the UE (e.g., using communication manager 140 and/or measurement component 1008, depicted in FIG. 10) may receive a first CSI report, generated by the UE in accordance with the configuration for periodic or aperiodic CSI reporting, as described above.

As further shown in FIG. 22, in some aspects, process 2200 may include receiving an aperiodic second CSI report generated by the UE if one or more conditions are met, the second CSI report containing one or more channel characteristic measurements associated with the first CSI report (block 2230). For example, the UE (e.g., using communication manager 140 and/or storage component 1010, depicted in FIG. 10) may receive an aperiodic second CSI report generated by the UE if one or more conditions are met, the second CSI report containing one or more channel characteristic measurements associated with the first CSI report, as described above.

Process 2200 may include additional aspects, such as any single aspect or any combination of aspects described below and/or in connection with one or more other processes described elsewhere herein.

In a first aspect, the one or more conditions are met if the network entity transmits a request for the UE to transmit the second CSI report is received.

In a second aspect, alone or in combination with the first aspect, the request is transmitted in response to determining a first CSI report transmission was missed.

In a third aspect, alone or in combination with one or more of the first and second aspects, the channel characteristic measurements associated with the first CSI report comprise at least one of RSRP, SINR, RI, PMI, CQI), or LI values.

In a fourth aspect, alone or in combination with one or more of the first through third aspects, the channel characteristic measurements associated with the first CSI report comprise one or more values not previously reported.

In a fifth aspect, alone or in combination with one or more of the first through fourth aspects, the aperiodic second CSI report has a lower priority than the one or more other types of CSI reports.

In a sixth aspect, alone or in combination with one or more of the first through fifth aspects, process 2200 includes receiving a report of a capability of the UE to buffer the channel characteristic measurements associated with the first CSI report.

In a seventh aspect, alone or in combination with one or more of the first through sixth aspects, the capability is indicated as a number of UCI bits the UE can buffer at a given time.

In an eighth aspect, alone or in combination with one or more of the first through seventh aspects, the UE indicates one or more capability indexes, wherein each capability index maps to a number of UCI bits.

In a ninth aspect, alone or in combination with one or more of the first through eighth aspects, the capability is implicitly indicated by a number of CPUs the UE supports, each CPU associated with a number of UCI bits.

In a tenth aspect, alone or in combination with one or more of the first through ninth aspects, the UE is considered as occupying additional CPUs after transmitting the first CSI report while buffering the one or more report quantities.

In an eleventh aspect, alone or in combination with one or more of the first through tenth aspects, the capability is indicated by reporting a number of CPUs the UE supports, and a number of UCI bits the UE supports per CPU.

In a twelfth aspect, alone or in combination with one or more of the first through eleventh aspects, the capability of the UE to buffer the channel characteristic measurements associated with the first CSI report is reported for activated serving cells.

In a thirteenth aspect, alone or in combination with one or more of the first through twelfth aspects, the capability of the UE to buffer the channel characteristic measurements associated with the first CSI report is reported as a shared capability among multiple serving cells.

In a fourteenth aspect, alone or in combination with one or more of the first through thirteenth aspects, the one or more conditions involve a report triggering state associated with a configuration of the second CSI report.

In a fifteenth aspect, alone or in combination with one or more of the first through fourteenth aspects, process 2200 includes the configuration of the second CSI report indicates an AP CSI triggering state association with the second CSI report.

In a sixteenth aspect, alone or in combination with one or more of the first through fifteenth aspects, the second CSI report is received via an uplink MAC-CE.

In a seventeenth aspect, alone or in combination with one or more of the first through sixteenth aspects, process 2200 includes receiving a request for the second CSI report, wherein the second CSI report is received via the uplink MAC-CE in response to the request.

In an eighteenth aspect, alone or in combination with one or more of the first through seventeenth aspects, the channel characteristic measurements associated with the first CSI report comprise one or more channel characteristic measurements not previously reported in the first CSI report.

Although FIG. 22 shows example blocks of process 2200, in some aspects, process 2200 may include additional blocks, fewer blocks, different blocks, or differently arranged blocks than those depicted in FIG. 22. Additionally, or alternatively, two or more of the blocks of process 2200 may be performed in parallel.

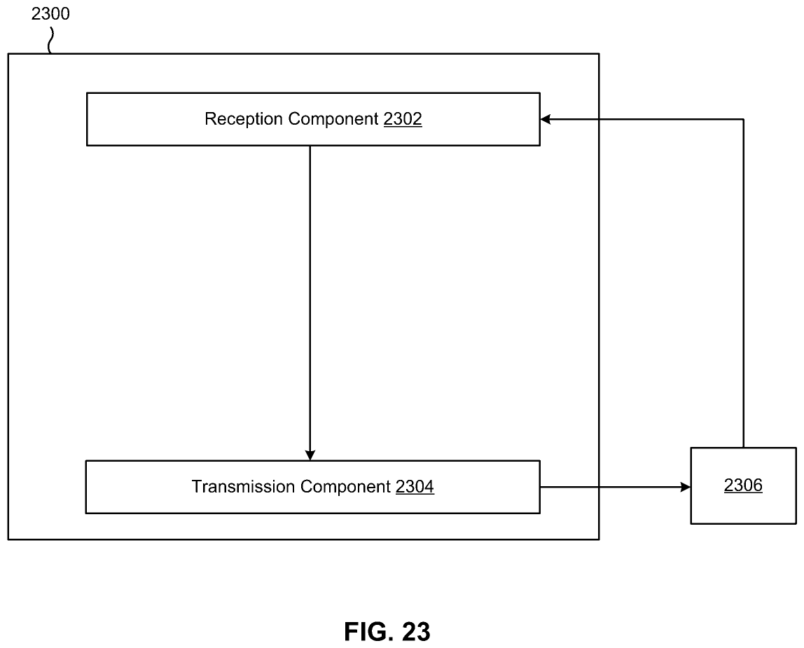

FIG. 23 is a diagram of an example apparatus 2300 for wireless communication. The apparatus 2300 may be a UE, or a UE may include the apparatus 2300. In some aspects, the apparatus 2300 includes a reception component 2302 and a transmission component 2304, which may be in communication with one another (for example, via one or more buses and/or one or more other components). As shown, the apparatus 2300 may communicate with another apparatus 2306 (such as a UE, a base station, or another wireless communication device) using the reception component 2302 and the transmission component 2304.

In some aspects, the apparatus 2300 may be configured to perform one or more operations described herein in connection with FIGS. 12-20. Additionally, or alternatively, the apparatus 2300 may be configured to perform one or more processes described herein, such as process 2100 of FIG. 21. In some aspects, the apparatus 2300 and/or one or more components shown in FIG. 23 may include one or more components of the UE described in connection with FIG. 2. Additionally, or alternatively, one or more components shown in FIG. 23 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2302 may receive communications, such as reference signals, control information, data communications, or a combination thereof, from the apparatus 2306. The reception component 2302 may provide received communications to one or more other components of the apparatus 2300. In some aspects, the reception component 2302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2300. In some aspects, the reception component 2302 may include one or more antennas, a modem, a demodulator, a MIMO detector, a receive processor, a controller/processor, a memory, or a combination thereof, of the UE described in connection with FIG. 2.

The transmission component 2304 may transmit communications, such as reference signals, control information, data communications, or a combination thereof, to the apparatus 2306. In some aspects, one or more other components of the apparatus 2300 may generate communications and may provide the generated communications to the transmission component 2304 for transmission to the apparatus 2306. In some aspects, the transmission component 2304 may perform signal processing on the generated communications (such as filtering, amplification, modulation, digital-to-analog conversion, multiplexing, interleaving, mapping, or encoding, among other examples), and may transmit the processed signals to the apparatus 2306. In some aspects, the transmission component 2304 may include one or more antennas, a modem, a modulator, a transmit MIMO processor, a transmit processor, a controller/processor, a memory, or a combination thereof, of the UE described in connection with FIG. 2. In some aspects, the transmission component 2304 may be co-located with the reception component 2302 in a transceiver.

The reception component 2302 may receive a configuration for periodic or aperiodic CSI reporting. The transmission component 2304 may transmit a first CSI report, in accordance with the configuration for periodic or aperiodic CSI reporting. The transmission component 2304 may transmit an aperiodic second CSI report containing one or more channel characteristic measurements associated with the first CSI report, if one or more conditions are met.

The transmission component 2304 may report a capability of the UE to buffer the channel characteristic measurements associated with the first CSI report. The determination component 2312 may clear bits of the buffered one or more report quantities in order to avoid exceeding the number of UCI bits the UE indicated it can support, wherein the bits are cleared based on how long they have been buffered. The determination component 2312 may release buffered bits of the channel characteristic measurements associated with the first CSI report a time period after transmission of the first CSI report. The reception component 2302 may receive a request for the second CSI report, wherein the second CSI report is transmitted via the uplink MAC-CE in response to the request.

The number and arrangement of components shown in FIG. 23 are provided as an example. In practice, there may be additional components, fewer components, different components, or differently arranged components than those shown in FIG. 23. Furthermore, two or more components shown in FIG. 23 may be implemented within a single component, or a single component shown in FIG. 23 may be implemented as multiple, distributed components. Additionally, or alternatively, a set of (one or more) components shown in FIG. 23 may perform one or more functions described as being performed by another set of components shown in FIG. 23.

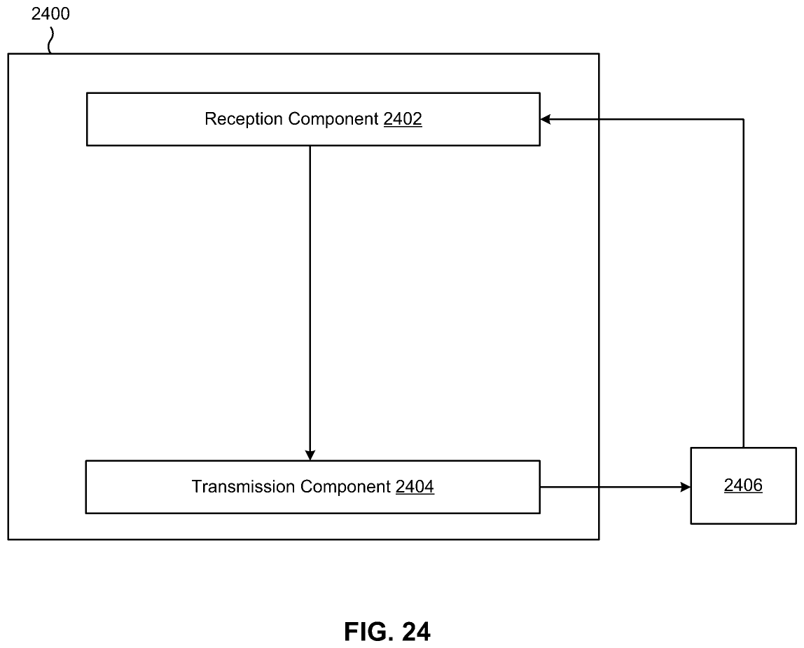

FIG. 24 is a diagram of an example apparatus 2400 for wireless communication. The apparatus 2400 may be a network entity, or a network entity may include the apparatus 2400. In some aspects, the apparatus 2400 includes a reception component 2402 and a transmission component 2404, which may be in communication with one another (for example, via one or more buses and/or one or more other components). As shown, the apparatus 2400 may communicate with another apparatus 2406 (such as a UE, a base station, or another wireless communication device) using the reception component 2402 and the transmission component 2404.

In some aspects, the apparatus 2400 may be configured to perform one or more operations described herein in connection with FIGS. 12-20. Additionally, or alternatively, the apparatus 2400 may be configured to perform one or more processes described herein, such as process 2200 of FIG. 22. In some aspects, the apparatus 2400 and/or one or more components shown in FIG. 24 may include one or more components of the network entity described in connection with FIG. 2. Additionally, or alternatively, one or more components shown in FIG. 24 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2402 may receive communications, such as reference signals, control information, data communications, or a combination thereof, from the apparatus 2406. The reception component 2402 may provide received communications to one or more other components of the apparatus 2400. In some aspects, the reception component 2402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2400. In some aspects, the reception component 2402 may include one or more antennas, a modem, a demodulator, a MIMO detector, a receive processor, a controller/processor, a memory, or a combination thereof, of the network entity described in connection with FIG. 2.

The transmission component 2404 may transmit communications, such as reference signals, control information, data communications, or a combination thereof, to the apparatus 2406. In some aspects, one or more other components of the apparatus 2400 may generate communications and may provide the generated communications to the transmission component 2404 for transmission to the apparatus 2406. In some aspects, the transmission component 2404 may perform signal processing on the generated communications (such as filtering, amplification, modulation, digital-to-analog conversion, multiplexing, interleaving, mapping, or encoding, among other examples), and may transmit the processed signals to the apparatus 2406. In some aspects, the transmission component 2404 may include one or more antennas, a modem, a modulator, a transmit MIMO processor, a transmit processor, a controller/processor, a memory, or a combination thereof, of the network entity described in connection with FIG. 2. In some aspects, the transmission component 2404 may be co-located with the reception component 2402 in a transceiver.

The transmission component 2404 may transmit a configuration to configure a UE for periodic or aperiodic CSI reporting. The reception component 2402 may receive a first CSI report, generated by the UE in accordance with the configuration for periodic or aperiodic CSI reporting. The reception component 2402 may receive an aperiodic second CSI report generated by the UE if one or more conditions are met, the second CSI report containing one or more channel characteristic measurements associated with the first CSI report.

The reception component 2402 may receive a report of a capability of the UE to buffer the channel characteristic measurements associated with the first CSI report. The reception component 2402 may receive a request for the second CSI report, wherein the second CSI report is received via the uplink MAC-CE in response to the request.

The number and arrangement of components shown in FIG. 24 are provided as an example. In practice, there may be additional components, fewer components, different components, or differently arranged components than those shown in FIG. 24. Furthermore, two or more components shown in FIG. 24 may be implemented within a single component, or a single component shown in FIG. 24 may be implemented as multiple, distributed components. Additionally, or alternatively, a set of (one or more) components shown in FIG. 24 may perform one or more functions described as being performed by another set of components shown in FIG. 24.

The following provides an overview of some Aspects of the present disclosure:

Aspect 1: A method of wireless communication performed by a user equipment (UE), comprising: receiving, from a network entity, a configuration associated with channel measurement resources (CMRs); performing downlink channel measurements associated with the CMRs, wherein the downlink channel measurements are associated with one or more time instances; storing the downlink channel measurements associated with the one or more time instances for a period of time at the UE; and transmitting, to the network entity and based at least in part on a request, at least a portion of the downlink channel measurements associated with the one or more time instances.

Aspect 2: The method of Aspect 1, further comprising: receiving, from the network entity and prior to an expiry of the period of time, the request for transmitting at least the portion of the downlink channel measurements.

Aspect 3: The method of any of Aspects 1 through 2, further comprising: transmitting, to the network entity and prior to an expiry of the period of time, the request for transmitting at least the portion of the downlink channel measurements.

Aspect 4: The method of any of Aspects 1 through 3, wherein the request indicates one or more of: a quantity of consecutive measurement occasions associated with the CMRs for the downlink channel measurements, CMR identifiers associated with the CMRs for the downlink channel measurements, or the time period associated with the downlink channel measurements.

Aspect 5: The method of any of Aspects 1 through 4, further comprising: transmitting, to the network entity, a UE capability report, wherein at least the portion of the downlink channel measurements is transmitted to the network entity based at least in part on the UE capability report.

Aspect 6: The method of Aspect 5, wherein the UE capability report indicates one or more of: a maximum quantity of consecutive measurement occasions associated with the CMRs that the UE is able to store, a maximum quantity of CMRs associated with a set of CMRs that the UE is able to store, or a maximum quantity of slots, symbols, or absolute time units that the UE is able to store.

Aspect 7: The method of any of Aspects 1 through 6, further comprising: discarding the downlink channel measurements after an expiry of the period of time.

Aspect 8: The method of any of Aspects 1 through 7, further comprising: determining predicted future downlink channel measurements based at least in part on the downlink channel measurements; and transmitting, to the network entity, the predicted future downlink channel measurements.

Aspect 9: The method of Aspect 8, further comprising: determining that a difference between additional downlink channel measurements and the predicted future downlink channel measurements satisfies a threshold; and transmitting, to the network entity and based at least in part on the difference satisfying the threshold, the request for transmitting at least the portion of the downlink channel measurements.

Aspect 10: A method of wireless communication performed by a network entity, comprising: transmitting, to a user equipment (UE), a configuration associated with channel measurement resources (CMRs); and receiving, from the UE and based at least in part on a request, at least a portion of downlink channel measurements stored for a period of time at the UE, wherein the downlink channel measurements are associated with the CMRs and with one or more time instances.

Aspect 11: The method of Aspect 10, further comprising: transmitting, to the UE and prior to an expiry of the period of time, the request for transmitting at least the portion of the downlink channel measurements.

Aspect 12: The method of any of Aspects 10 through 11, further comprising: receiving, from the UE and prior to an expiry of the period of time, the request for transmitting at least the portion of the downlink channel measurements.

Aspect 13: The method of any of Aspects 10 through 12, further comprising: receiving, from the UE, a UE capability report, wherein at least the portion of the downlink channel measurements is based at least in part on the UE capability report.

Aspect 14: The method of any of Aspects 10 through 13, further comprising: receiving, from the UE, predicted future downlink channel measurements, wherein the predicted future downlink channel measurements are based at least in part on the downlink channel measurements; and receiving, from the UE and based at least in part on a difference between additional downlink channel measurements and the predicted future downlink channel measurements satisfying a threshold, the request for transmitting at least the portion of the downlink channel measurements.

Aspect 15: The method of any of Aspects 10 through 14, wherein at least the portion of the downlink channel measurements is associated with an aperiodic channel state information measurement reporting.

Aspect 16: An apparatus for wireless communication at a device, comprising a processor; memory coupled with the processor; and instructions stored in the memory and executable by the processor to cause the apparatus to perform the method of one or more of Aspects 1-9.

Aspect 17: A device for wireless communication, comprising a memory and one or more processors coupled to the memory, the one or more processors configured to perform the method of one or more of Aspects 1-9.

Aspect 18: An apparatus for wireless communication, comprising at least one means for performing the method of one or more of Aspects 1-9.

Aspect 19: A non-transitory computer-readable medium storing code for wireless communication, the code comprising instructions executable by a processor to perform the method of one or more of Aspects 1-9.

Aspect 20: A non-transitory computer-readable medium storing a set of instructions for wireless communication, the set of instructions comprising one or more instructions that, when executed by one or more processors of a device, cause the device to perform the method of one or more of Aspects 1-9.

Aspect 21: An apparatus for wireless communication at a device, comprising a processor; memory coupled with the processor; and instructions stored in the memory and executable by the processor to cause the apparatus to perform the method of one or more of Aspects 10-15.

Aspect 22: A device for wireless communication, comprising a memory and one or more processors coupled to the memory, the one or more processors configured to perform the method of one or more of Aspects 10-15.

Aspect 23: An apparatus for wireless communication, comprising at least one means for performing the method of one or more of Aspects 10-15.

Aspect 24: A non-transitory computer-readable medium storing code for wireless communication, the code comprising instructions executable by a processor to perform the method of one or more of Aspects 10-15.

Aspect 25: A non-transitory computer-readable medium storing a set of instructions for wireless communication, the set of instructions comprising one or more instructions that, when executed by one or more processors of a device, cause the device to perform the method of one or more of Aspects 10-15.

Aspect 26: A method of wireless communication performed by a user equipment (UE), comprising: receiving a configuration for periodic or aperiodic channel state information (CSI) reporting; transmitting a first CSI report, in accordance with the configuration for periodic or aperiodic CSI reporting; and transmitting an aperiodic second CSI report containing one or more channel characteristic measurements associated with the first CSI report, if one or more conditions are met.

Aspect 27: The method of Aspect 26, wherein the one or more conditions are met if the UE receives a request to transmit the second CSI report.

Aspect 28: The method of Aspect 27, wherein: the UE buffers the channel characteristic measurements associated with the first CSI report for a time duration after transmitting the first CSI report; and the UE expects to receive the request within the time duration.

Aspect 29: The method of any of Aspects 26 through 28, wherein the channel characteristic measurements associated with the first CSI report comprise at least one of: reference signal received power (RSRP), signal to interference and noise ratio (SINR), rank indicator (RI), precoding matrix indicator (PMI), channel quality indicator CQI), or layer indicator (LI) values.

Aspect 30: The method of any of Aspects 26 through 29, wherein the channel characteristic measurements associated with the first CSI report comprise one or more values not previously reported.

Aspect 31: The method of any of Aspects 26 through 30, wherein the aperiodic second CSI report has a lower priority than the one or more other types of CSI reports.

Aspect 32: The method of any of Aspects 26 through 31, further comprising reporting a capability of the UE to buffer the channel characteristic measurements associated with the first CSI report.

Aspect 33: The method of Aspect 32, wherein the capability is indicated as a number of uplink control information (UCI) bits the UE can buffer at a given time.

Aspect 34: The method of Aspect 33, wherein the UE indicates one or more capability indexes, wherein each capability index maps to a number of UCI bits.

Aspect 35: The method of Aspect 33, wherein the capability is implicitly indicated by a number of CSI processing units (CPUs) the UE supports, each CPU associated with a number of UCI bits.

Aspect 36: The method of Aspect 35, wherein the UE occupies additional CPUs after transmitting the first CSI report while buffering the one or more report quantities.

Aspect 37: The method of Aspect 32, further comprising: clearing bits of the buffered one or more report quantities in order to avoid exceeding the number of UCI bits the UE indicated it can support, wherein the bits are cleared based on how long they have been buffered.

Aspect 38: The method of Aspect 32, wherein the capability is indicated by reporting: a number of CSI processing units (CPUs) the UE supports; and a number of UCI bits the UE supports per CPU.

Aspect 39: The method of Aspect 32, wherein the capability of the UE to buffer the channel characteristic measurements associated with the first CSI report is reported for activated serving cells.

Aspect 40: The method of Aspect 32, wherein the capability of the UE to buffer the channel characteristic measurements associated with the first CSI report is reported as a shared capability among multiple serving cells.

Aspect 41: The method of any of Aspects 26 through 40, further comprising releasing buffered bits of the channel characteristic measurements associated with the first CSI report a time period after transmission of the first CSI report.

Aspect 42: The method of any of Aspects 26 through 41, wherein: the first report is associated with a periodic or semi-persistent (SP) CSI report setting; and the UE released buffered bits of the channel characteristic measurements associated with the first CSI report, such that buffered UCI payload bits are replaced by UCI payload bits of a same series of periodic or SP, after a subsequent CSI report is.

Aspect 43: The method of any of Aspects 26 through 42, wherein the one or more conditions involve a report triggering state associated with a configuration of the second CSI report.

Aspect 44: The method of Aspect 43, wherein: the configuration of the second CSI report indicates an aperiodic (AP) CSI triggering state association with the second CSI report.

Aspect 45: The method of any of Aspects 26 through 44, wherein the second CSI report is transmitted via an uplink medium access control (MAC) control element (CE).

Aspect 46: The method of Aspect 45, further comprising: receiving a request for the second CSI report, wherein the second CSI report is transmitted via the uplink MAC-CE in response to the request.

Aspect 47: The method of any of Aspects 26 through 46, wherein the channel characteristic measurements associated with the first CSI report comprise one or more channel characteristic measurements not previously reported in the first CSI report.

Aspect 48: A method of wireless communication by a network entity, comprising: transmitting a configuration to configure a user equipment (UE) for periodic or aperiodic channel state information (CSI) reporting; receiving a first CSI report, generated by the UE in accordance with the configuration for periodic or aperiodic CSI reporting; and receiving an aperiodic second CSI report generated by the UE if one or more conditions are met, the second CSI report containing one or more channel characteristic measurements associated with the first CSI report.

Aspect 49: The method of Aspect 48, wherein the one or more conditions are met if the network entity transmits a request for the UE to transmit the second CSI report is received.

Aspect 50: The method of Aspect 49, wherein the request is transmitted in response to determining a first CSI report transmission was missed.

Aspect 51: The method of any of Aspects 48 through 50, wherein the channel characteristic measurements associated with the first CSI report comprise at least one of: reference signal received power (RSRP), signal to interference and noise ratio (SINR), rank indicator (RI), precoding matrix indicator (PMI), channel quality indicator CQI), or layer indicator (LI) values.

Aspect 52: The method of any of Aspects 48 through 51, wherein the channel characteristic measurements associated with the first CSI report comprise one or more values not previously reported.

Aspect 53: The method of any of Aspects 48 through 52, wherein the aperiodic second CSI report has a lower priority than the one or more other types of CSI reports.

Aspect 54: The method of any of Aspects 48 through 53, further comprising receiving a report of a capability of the UE to buffer the channel characteristic measurements associated with the first CSI report.

Aspect 55: The method of Aspect 54, wherein the capability is indicated as a number of uplink control information (UCI) bits the UE can buffer at a given time.

Aspect 56: The method of Aspect 55, wherein the UE indicates one or more capability indexes, wherein each capability index maps to a number of UCI bits.

Aspect 57: The method of Aspect 55, wherein the capability is implicitly indicated by a number of CSI processing units (CPUs) the UE supports, each CPU associated with a number of UCI bits.

Aspect 58: The method of Aspect 57, wherein the UE is considered as occupying additional CPUs after transmitting the first CSI report while buffering the one or more report quantities.

Aspect 59: The method of Aspect 54, wherein the capability is indicated by reporting: a number of CSI processing units (CPUs) the UE supports; and a number of UCI bits the UE supports per CPU.

Aspect 60: The method of Aspect 54, wherein the capability of the UE to buffer the channel characteristic measurements associated with the first CSI report is reported for activated serving cells.

Aspect 61: The method of Aspect 54, wherein the capability of the UE to buffer the channel characteristic measurements associated with the first CSI report is reported as a shared capability among multiple serving cells.

Aspect 62: The method of any of Aspects 48 through 61, wherein the one or more conditions involve a report triggering state associated with a configuration of the second CSI report.

Aspect 63: The method of Aspect 62, wherein: the configuration of the second CSI report indicates an aperiodic (AP) CSI triggering state association with the second CSI report.

Aspect 64: The method of any of Aspects 48 through 63, wherein the second CSI report is received via an uplink medium access control (MAC) control element (CE).

Aspect 65: The method of Aspect 64, further comprising: receiving a request for the second CSI report, wherein the second CSI report is received via the uplink MAC-CE in response to the request.

Aspect 66: The method of any of Aspects 48 through 65, wherein the channel characteristic measurements associated with the first CSI report comprise one or more channel characteristic measurements not previously reported in the first CSI report.

Aspect 67: An apparatus for wireless communication at a device, comprising a processor; memory coupled with the processor; and instructions stored in the memory and executable by the processor to cause the apparatus to perform the method of one or more of Aspects 26-47.

Aspect 68: A device for wireless communication, comprising a memory and one or more processors coupled to the memory, the one or more processors configured to perform the method of one or more of Aspects 26-47.

Aspect 69: An apparatus for wireless communication, comprising at least one means for performing the method of one or more of Aspects 26-47.

Aspect 70: A non-transitory computer-readable medium storing code for wireless communication, the code comprising instructions executable by a processor to perform the method of one or more of Aspects 26-47.

Aspect 71: A non-transitory computer-readable medium storing a set of instructions for wireless communication, the set of instructions comprising one or more instructions that, when executed by one or more processors of a device, cause the device to perform the method of one or more of Aspects 26-47.

Aspect 72: An apparatus for wireless communication at a device, comprising a processor; memory coupled with the processor; and instructions stored in the memory and executable by the processor to cause the apparatus to perform the method of one or more of Aspects 48-66.

Aspect 73: A device for wireless communication, comprising a memory and one or more processors coupled to the memory, the one or more processors configured to perform the method of one or more of Aspects 48-66.

Aspect 74: An apparatus for wireless communication, comprising at least one means for performing the method of one or more of Aspects 48-66.

Aspect 75: A non-transitory computer-readable medium storing code for wireless communication, the code comprising instructions executable by a processor to perform the method of one or more of Aspects 48-66.

Aspect 76: A non-transitory computer-readable medium storing a set of instructions for wireless communication, the set of instructions comprising one or more instructions that, when executed by one or more processors of a device, cause the device to perform the method of one or more of Aspects 48-66.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive, from a network entity, a configuration associated with channel measurement resources (CMRs);
perform downlink channel measurements associated with the CMRs,
wherein the downlink channel measurements are associated with one or more time instances;
store the downlink channel measurements associated with the one or more time instances for a period of time at the UE; and
transmit, to the network entity and based at least in part on a request, at least a portion of the downlink channel measurements associated with the one or more time instances.

2. The apparatus of claim 1, wherein the one or more processors are further configured to:
receive, from the network entity and prior to an expiry of the period of time, the request for transmitting at least the portion of the downlink channel measurements.

3. The apparatus of claim 1, wherein the one or more processors are further configured to:
transmit, to the network entity and prior to an expiry of the period of time, the request for transmitting at least the portion of the downlink channel measurements.

4. The apparatus of claim 1, wherein the request indicates one or more of: a quantity of consecutive measurement occasions associated with the CMRs for the downlink channel measurements, CMR identifiers associated with the CMRs for the downlink channel measurements, or the time period associated with the downlink channel measurements.

5. The apparatus of claim 1, wherein the one or more processors are further configured to:
transmit, to the network entity, a UE capability report, wherein at least the portion of the downlink channel measurements is transmitted to the network entity based at least in part on the UE capability report.

6. The apparatus of claim 5, wherein the UE capability report indicates one or more of: a maximum quantity of consecutive measurement occasions associated with the CMRs that the UE is able to store, a maximum quantity of CMRs associated with a set of CMRs that the UE is able to store, or a maximum quantity of slots, symbols, or absolute time units that the UE is able to store.

7. The apparatus of claim 1, wherein the one or more processors are further configured to:
discard the downlink channel measurements after an expiry of the period of time.

8. The apparatus of claim 1, wherein the one or more processors are further configured to:
determine predicted future downlink channel measurements based at least in part on the downlink channel measurements; and
transmit, to the network entity, the predicted future downlink channel measurements.

9. The apparatus of claim 8, wherein the one or more processors are further configured to:
determine that a difference between additional downlink channel measurements and the predicted future downlink channel measurements satisfies a threshold; and
transmit, to the network entity and based at least in part on the difference satisfying the threshold, the request for transmitting at least the portion of the downlink channel measurements.

10. An apparatus for wireless communication at a network entity, comprising:
a memory; and
one or more processors, coupled to the memory, configured to:
transmit, to a user equipment (UE), a configuration associated with channel measurement resources (CMRs); and
receive, from the UE and based at least in part on a request, at least a portion of downlink channel measurements stored for a period of time at the UE, wherein the downlink channel measurements are associated with the CMRs and with one or more time instances.

11. The apparatus of claim 10, wherein the one or more processors are further configured to:
transmit, to the UE and prior to an expiry of the period of time, the request for transmitting at least the portion of the downlink channel measurements.

12. The apparatus of claim 10, wherein the one or more processors are further configured to:
receive, from the UE and prior to an expiry of the period of time, the request for transmitting at least the portion of the downlink channel measurements.

13. The apparatus of claim 10, wherein the one or more processors are further configured to:
receive, from the UE, a UE capability report, wherein at least the portion of the downlink channel measurements is based at least in part on the UE capability report.

14. The apparatus of claim 10, wherein the one or more processors are further configured to:
receive, from the UE, predicted future downlink channel measurements, wherein the predicted future downlink channel measurements are based at least in part on the downlink channel measurements; and
receive, from the UE and based at least in part on a difference between additional downlink channel measurements and the predicted future downlink channel measurements satisfying a threshold, the request for transmitting at least the portion of the downlink channel measurements.

15. The apparatus of claim 10, wherein at least the portion of the downlink channel measurements is associated with an aperiodic channel state information measurement reporting.

16. A method of wireless communication performed by a user equipment (UE), comprising:
receiving, from a network entity, a configuration associated with channel measurement resources (CMRs);
performing downlink channel measurements associated with the CMRs, wherein the downlink channel measurements are associated with one or more time instances;
storing the downlink channel measurements associated with one or more time instances for a period of time at the UE; and
transmitting, to the network entity and based at least in part on a request, at least a portion of the downlink channel measurements associated with the one or more time instances.

17. The method of claim 16, further comprising:
receiving, from the network entity and prior to an expiry of the period of time, the request for transmitting at least the portion of the downlink channel measurements.

18. The method of claim 16, further comprising:
transmitting, to the network entity and prior to an expiry of the period of time, the request for transmitting at least the portion of the downlink channel measurements.

19. The method of claim 16, wherein the request indicates one or more of: a quantity of consecutive measurement occasions associated with the CMRs for the downlink channel measurements, CMR identifiers associated with the CMRs for the downlink channel measurements, or the time period associated with the downlink channel measurements.

20. The method of claim 16, further comprising:
transmitting, to the network entity, a UE capability report, wherein at least the portion of the downlink channel measurements is transmitted to the network entity based at least in part on the UE capability report.

21. The method of claim 20, wherein the UE capability report indicates one or more of: a maximum quantity of consecutive measurement occasions associated with the CMRs that the UE is able to store, a maximum quantity of CMRs associated with a set of CMRs that the UE is able to store, or a maximum quantity of slots, symbols, or absolute time units that the UE is able to store.

22. The method of claim 16, further comprising:
discarding the downlink channel measurements after an expiry of the period of time.

23. The method of claim 16, further comprising:
determining predicted future downlink channel measurements based at least in part on the downlink channel measurements; and
transmitting, to the network entity, the predicted future downlink channel measurements.

24. The method of claim 23, further comprising:
determining that a difference between additional downlink channel measurements and the predicted future downlink channel measurements satisfies a threshold; and
transmitting, to the network entity and based at least in part on the difference satisfying the threshold, the request for transmitting at least the portion of the downlink channel measurements.

25. A method of wireless communication performed by a network entity, comprising:
transmitting, to a user equipment (UE), a configuration associated with channel measurement resources (CMRs); and
receiving, from the UE and based at least in part on a request, at least a portion of downlink channel measurements stored for a period of time at the UE, wherein the downlink channel measurements are associated with the CMRs and with one or more time instances.

26. The method of claim 25, further comprising:
transmitting, to the UE and prior to an expiry of the period of time, the request for transmitting at least the portion of the downlink channel measurements.

27. The method of claim 25, further comprising:
receiving, from the UE and prior to an expiry of the period of time, the request for transmitting at least the portion of the downlink channel measurements.

28. The method of claim 25, further comprising:
receiving, from the UE, a UE capability report, wherein at least the portion of the downlink channel measurements is based at least in part on the UE capability report.

29. The method of claim 25, further comprising:
receiving, from the UE, predicted future downlink channel measurements, wherein the predicted future downlink channel measurements are based at least in part on the downlink channel measurements; and
receiving, from the UE and based at least in part on a difference between additional downlink channel measurements and the predicted future downlink channel measurements satisfying a threshold, the request for transmitting at least the portion of the downlink channel measurements.

30. The method of claim 25, wherein at least the portion of the downlink channel measurements is associated with an aperiodic channel state information measurement reporting.
